(19) United States
(12) Patent Application Publication
(10) Pub. No.: US 2024/0332639 A1
(43) Pub. Date: Oct. 3, 2024

(54) ELECTRODE STRUCTURE, SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Wataru UNO, Yokohama Kanagawa (JP); Hayato SEKI, Kawasaki Kanagawa (JP); Yasuyuki HOTTA, Ota Tokyo (JP); Keigo HOSHINA, Yokohama Kanagawa (JP)

(73) Assignee: KABUSHIKI KAISHA TOSHIBA, Tokyo (JP)

(21) Appl. No.: 18/441,521

(22) Filed: Feb. 14, 2024

(30) Foreign Application Priority Data
Mar. 27, 2023 (JP) 2023-049781

(51) Int. Cl. H01M 10/42; B60L 3/00; B60L 50/64; H01M 4/02; H01M 50/209; H01M 50/296; H01M 50/509; H01M 50/574

(52) U.S. Cl. CPC H01M 10/4235; B60L 3/0046; B60L 50/64; H01M 50/209; H01M 50/296; H01M 50/509; H01M 50/574; H01M 2004/021; H01M 2004/028; H01M 2220/20

(57) ABSTRACT

An electrode structure for a secondary battery includes an electrode and a composite layer. In a cumulative frequency distribution of inorganic particles having average particle size of 3 μm or more with respect to a thickness direction of the composite layer, a first region is set to a range 0 or more and less than 25 and the second region is set to a range 25 or more and 100 or less. The first region is 5% or more and 40% or less of the thickness of the composite layer. Average particle size of inorganic particles satisfy a relationship of R1<R2.

### CROSS-REFERENCE TO RELATED APPLICATIONS

This application is based upon and claims the benefit of priority from Japanese Patent Application No. 2023-049781 filed on Mar. 27, 2023, and the entire contents of which are incorporated herein by reference.

### FIELD

Embodiments described herein relate generally to an electrode structure, a secondary battery, a battery pack, a vehicle, and a stationary power supply.

### BACKGROUND

A nonaqueous electrolyte battery such as a secondary battery is used as a power supply in a wide range of fields.

The form of the nonaqueous electrolyte battery ranges from a small battery for various electronic devices to a large battery for electric vehicles.

Since the nonaqueous electrolyte battery uses a nonaqueous electrolyte containing a flammable material such as ethylene carbonate, safety measures are required.

As a secondary battery, an aqueous electrolyte battery using an aqueous electrolyte containing an aqueous solvent having no flammability instead of the nonaqueous electrolyte has also been developed.

In the above-described secondary battery, suppression of electrolysis of water generated by a side reaction and reduction in resistance are required to be simultaneously achieved.

### BRIEF DESCRIPTION OF THE DRAWINGS

FIG. 1 is a cross-sectional view schematically illustrating an electrode structure according to an embodiment.

FIG. 2A is another cross-sectional view schematically illustrating the electrode structure according to the embodiment and FIG. 2B is a diagram showing a cumulative frequency distribution according to the embodiment.

FIG. 3 is a cross-sectional view schematically illustrating an example of a secondary battery according to an embodiment.

FIG. 4 is a cross-sectional view taken along line IV-IV of the secondary battery illustrated in FIG. 3.

FIG. 5 is a partially cutaway perspective view schematically illustrating another example of the secondary battery according to the embodiment.

FIG. 6 is an enlarged cross-sectional view of a part B of the secondary battery illustrated in FIG. 5.

FIG. 7 is a perspective view schematically illustrating an example of an assembled battery according to an embodiment.

FIG. 8 is a perspective view schematically illustrating an example of a battery pack according to an embodiment.

FIG. 9 is an exploded perspective view schematically illustrating another example of the battery pack according to the embodiment.

FIG. 10 is a block diagram illustrating an example of an electric circuit of the battery pack illustrated in FIG. 9.

FIG. 11 is a partially transparent view schematically illustrating an example of a vehicle according to an embodiment.

FIG. 12 is a block diagram illustrating an example of a system including a stationary power supply according to an embodiment.

### DETAILED DESCRIPTION

Hereinafter, embodiments will be described with reference to the accompanying drawings.

Note that, in the following description, components exhibiting the same or similar function are denoted by the same reference numeral throughout the entire drawings, and redundant description will be omitted. Note that, respective drawings are schematic views for explaining the embodiments and facilitating understanding thereof, and shapes, dimensions, ratios, and the like are different from those of an actual device, but these can be appropriately modified in design in consideration of the following description and known technologies.

### First Embodiment

An electrode structure for a secondary battery according to a first embodiment includes an electrode and a composite layer containing inorganic particles. The composite layer includes a first region and a second region. The first region exists between the electrode and the second region. In a cumulative frequency distribution of the inorganic particles having an average particle size of 3 μm or more in the composite layer with respect to a thickness direction of the composite layer, when the total number of the inorganic particles having an average particle size of 3 μm or more is normalized to 100, and the first region is set to a range where a cumulative frequency of the inorganic particles having an average particle size of 3 μm or more is 0 or more and less than 25, the first region is 5% or more and 40% or less of the thickness of the composite layer from an interface between the electrode and the composite layer. In a cross-sectional SEM image of the composite layer, an average particle size R1 of the inorganic particles in the first region and an average particle size R2 of the inorganic particles in the second region satisfy a relationship of R1<R2.

In the electrode structure having the above-described configuration, the composite layer that functions as a separator when incorporated into a secondary battery is formed on an electrode. In the composite layer, when the average particle size R1 of the inorganic particles in the first region and the average particle size R2 of the inorganic particles in the second region satisfy the relationship of R1<R2, it is possible to reduce resistance while suppressing electrolysis of water accompanying a side reaction. The reason for this is as follows. With regard to suppression of the electrolysis of water accompanying the side reaction, since the average particle size of the inorganic particles in the second region is large, water in the electrolyte can be suppressed from flowing into an active material-containing layer. In addition, with regard to reduction in resistance, since the average particle size of the inorganic particles in the first region is small, movement of Li ions can be sufficiently accelerated at an interface between the composite layer and the active material-containing layer, and the resistance acting on the interface can be lowered.

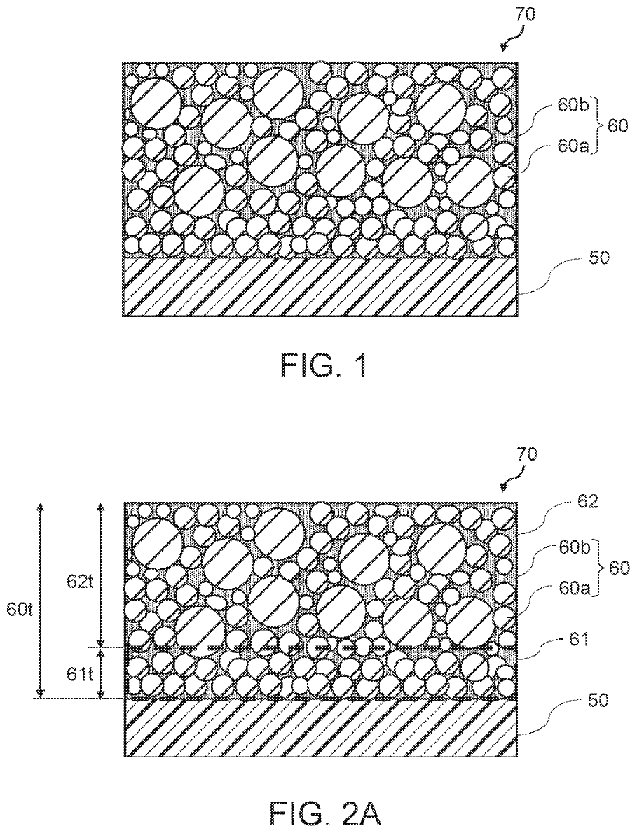

FIG. 1 is a cross-sectional view schematically illustrating an electrode structure according to an embodiment. An electrode structure 70 includes an electrode 50 and a composite layer 60 containing inorganic particles. Although described later, the electrode 50 includes a current collector and an active material-containing layer (not illustrated).

The composite layer 60 includes inorganic particles 60a. The composite layer 60 further includes a resin 60b. Materials that can be used for the inorganic particles 60a and the resin 60b will be described later in the section of (composite layer).

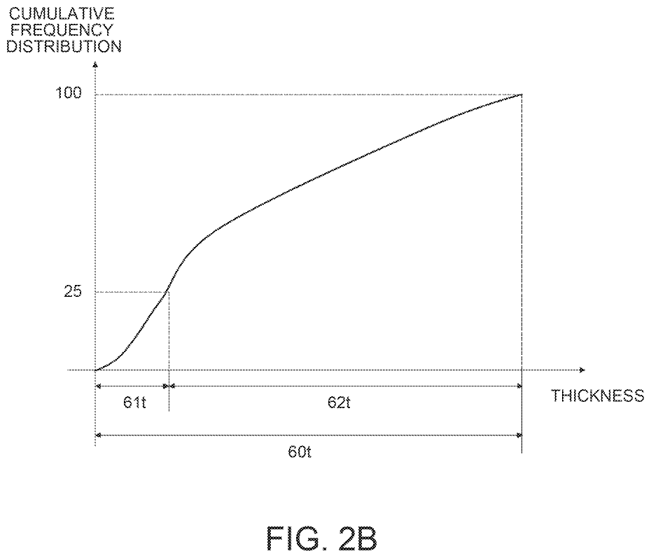

The composite layer 60 includes a first region and a second region. The first region exists between the electrode and the second region. Here, the first region and the second region will be described with reference to FIG. 2.

FIG. 2A is a cross-sectional view schematically illustrating the electrode structure according to the embodiment. In FIG. 2A, the thickness of the composite layer 60 along a thickness direction of the electrode structure 70 is set to 60t.

Here, the first region and the second region are defined as follows. A cumulative frequency distribution of inorganic particles having an average particle size of 3 μm or more in the composite layer is drawn in a direction of 60t which is a thickness direction of the composite layer, and the number of all inorganic particles having an average particle size of 3 μm or more is normalized to 100. At this time, a range where the cumulative frequency of the inorganic particles is 0 or more and less than 25 with respect to the thickness direction of the composite layer is defined as the first region, and a range where the inorganic particles exist in the composite layer except for the first region, that is, a range where the cumulative frequency is 25 or more and 100 or less is defined as the second region. Here, when the number of inorganic particles having an average particle size of 3 μm or more in the composite layer is 0, the entire composite layer is defined as the first region. A ratio of the thickness 61t of the first region or the thickness 62t of the second region to the thickness 60t of the composite layer is hereinafter referred to as a thickness ratio [%] of the first region 61 or a thickness ratio [%] of the second region 62. FIG. 2B is a diagram showing a cumulative frequency distribution of the embodiment. FIG. 2B shows a diagram showing a cumulative frequency distribution having average particle size of 3 μm or more.

The thickness ratio of the first region 61, that is, a ratio of the thickness 61t of the first region to the thickness 60t of the composite layer is preferably 5% or more and 40% or less. When the thickness ratio of the first region 61 is 40% or less, the thickness ratio of the second region 62 increases, and a side reaction can be suppressed. This is because the thickness ratio of the second region containing a large amount of inorganic particles having an average particle size of 3 μm or more is sufficiently larger than that of the first region 61. As described above, when solvent molecules such as water in the electrolyte move toward the electrode 50, a movement path of the solvent molecules through pores of the composite layer 60 becomes longer than a linear distance in which the solvent molecules move in the thickness direction of the composite layer 60. At this time, since a movement speed of solvent molecules such as water having a size close to a pore size from the composite layer to the active material-containing layer is suppressed in comparison to lithium having a small ionic radius, a side reaction including electrolysis of water in the electrode 50 can be suppressed.

When the thickness ratio of the first region is 5% or more, resistance can be reduced. That is, in the first region 61, a path through which Li ions move is shorter in comparison to the second region. Therefore, movement of Li ions can be sufficiently accelerated at the interface between the composite layer 60 and the active material-containing layer, and the resistance acting on the interface can be reduced. With regard to the solvent molecule such as water, since a path through which water in the electrolyte moves is long in the second region 62, inflow into the active material-containing layer can be suppressed in the first region. In addition, in the first region in the vicinity of the interface between the composite layer 60 and the active material-containing layer, it is considered that suppression of a side reaction and reduction in resistance are achieved simultaneously in an electrode structure or a battery by shortening the path through which Li ions move, and reducing the resistance acting on the interface. The thickness ratio of the first region 61 is more preferably 8% or more and 30% or less, and still more preferably 10% or more and 20% or less. In other words, the position at which the cumulative frequency distribution is 25 can be said the boundary between the first region and the second region. This boundary is preferably 5% or more and 40% or less of the thickness of the composite layer from an interface between the electrode and the composite layer. It is more preferably 8% or more and 30% or less, and still more preferably 10% or more and 20% or less.

The measurement relating to the thickness ratio of the first region and the second region is performed, for example, as follows.

### <Measurement Relating to Thickness Ratio of First Region and Second Region>

### (Pretreatment of Secondary Battery)

First, after the secondary battery is brought into a discharged state, the secondary battery is disassembled to collect an electrode group including the composite layer. The disassembly may be performed in the air in a case of an aqueous lithium ion battery, but is performed in a glove box under an inert gas atmosphere such as argon in a case of a lithium ion battery using a nonaqueous solvent. The discharged state represents a state in which the battery is discharged until a charge rate of the battery reaches 0%. In a case of the aqueous lithium ion battery, after the taken-out electrode group is immersed in pure water for 3 minutes, the electrode group is dried at 100° C. for 5 minutes. In a case of the lithium ion battery using a nonaqueous solvent, after the taken-out electrode group is immersed in the solvent for 3 minutes, the electrode group is dried in a glove box under an inert gas atmosphere. As the solvent, for example, diethyl carbonate is used.

### (Cutting of Electrode Group)

Next, the electrode group is subjected to focused ion beam (FIB) processing, and a cut cross-section is observed with a scanning electron microscope (SEM). Here, as an FIB apparatus, for example, SMI3300SE manufactured by Hitachi and Strata 400s manufactured by FEI can be used. As the cutting of the electrode group, cutting is performed at a position equally dividing a main surface of the electrode group into six in a short side direction when viewed from an upper side to obtain five cross sections.

(Observation of Cross-Section of Electrode Structure) After obtaining the cross-sections of the electrode group by the FIB processing, each of the cross-sections of the electrode structure 70 including the electrode 50 and the composite layer 60 is observed with an SEM. As an SEM apparatus, for example, U8020 manufactured by Hitachi High-Technologies Corporation can be used. As an observation site of the SEM, a region where the electrode 50 and the composite layer 60 exist is selected, and in the selected region, the cross-section is imaged at a magnification such that the entirety of the electrode 50 and the composite layer 60 are included in the observation region.

### (Binarization of SEM Image)

An obtained SEM image is binarized by ImageJ in which a median value between luminosity of the inorganic particles 60a and luminosity of the resin 60b in the composite layer 60 is set as a threshold value.

### (Calculation of Thickness Ratio of First Region and Second Region)

With respect to the binarized SEM image, after spherical 1 or roughly spherical particles having high luminosity are detected in the composite layer, a one-particle average particle size Rp [μm] which is an arithmetic average value of a maximum value and a minimum value of a size in each particle is obtained. An average particle size of each particle can be calculated by obtaining each Rp of all particles included in the first region 61 by arithmetically averaging. Particles having an average particle size Rp of 3 μm or more are detected in the composite layer, and a cumulative frequency distribution of inorganic particles having an average particle size Rp of 3 μm or more in the composite layer 60 is drawn with respect to a thickness direction from an interface between the electrode 50 and the composite layer 60 to a surface of the composite layer 60 facing the interface. At that time, the number of all inorganic particles having an average particle size Rp of 3 μm or more is normalized to 100. At this time, with respect to an axial direction of the thickness 60t of the composite layer 60, a range where the cumulative frequency of the inorganic particles is 0 or more and less than 25 is defined as the first region, and a range where the cumulative frequency is 25 or more and 100 or less is defined as the second region. However, it is assumed that the first region includes an interface between the electrode and the composite layer, and when the number of inorganic particles having an average particle size of 3 μm in the composite layer is 0, the entire composite layer is defined as the first region. The ratio of the thickness 61t of the first region 61 or the thickness 62t of the second region 62 to the thickness 60t of the composite layer is hereinafter referred to as a thickness ratio [%] of the first region 61 or a thickness ratio [%] of the second region 62.

The operations from (observation of the cross-section of the electrode structure) to (calculation of the ratio of the first region and the second region) described above are performed on each cross-section, and the ratio of the thickness 61t of the first region 61 to the thickness 60t of the composite layer 60 obtained in the cross-section is arithmetically averaged. In the following measurement, the arithmetically averaged value is used for the range of the first region.

Next, in the cross-sectional SEM image of the composite layer 60 included in the electrode structure according to this embodiment, the average particle size R1 of the inorganic particles 60b in the first region 61 and the average particle size R2 of the inorganic particles 60a in the second region 62 satisfy a relationship of R1<R2. When R2 is larger than R1, the average particle size of the inorganic particles in the second region is increased. According to this, since the path through which water in the electrolyte moves in the second region is lengthened, a side reaction can be suppressed.

The ratio R1/R2 of the average particle size R1 to the average particle size R2 is preferably 0.01 or more and 0.8 or less. When R1 calculated in the measurement of the average particle size of the inorganic particles 60a to be described later is 0.2 μm or more and 3 μm or less, and R2 is 3 μm or more, the reason why the ratio R1/R2 is preferably 0.01 or more and 0.8 or less will be described later. When R1 and R2 are 0.2 μm or more and 3 μm or less, and 3 μm or more, respectively, and the ratio R1/R2 is 0.8 or less according to a measurement method to be described later, the average particle size of the second region when the first region is set as a reference is increased. Therefore, since a path through which water in the electrolyte moves in the second region becomes long, a side reaction can be suppressed. On the other hand, when R1 and R2 are 0.2 μm or more and 3 μm or less, and 3 μm or more, respectively, and the ratio R1/R2 is 0.01 or more according to the measurement method to be described later, the average particle size of the second region when the first region is set as a reference becomes 100 times. According to this, a difference in the length of the movement path of Li ions and water in the electrolyte in each of the first region and the second region and a difference in the concentration distribution of Li ions and water molecules generated in the thickness direction of the composite layer are not excessive, and a concentration overvoltage generated in the composite layer is reduced. As a result the resistance is low. R1/R2 is more preferably 0.1 or more and 0.7 or less, and still more preferably 0.25 or more and 0.5 or less.

The method of measuring the average particle size of the inorganic particles 60a of the composite layer is conducted, for example, as follows.

### <Measurement of Average Particle Size of Inorganic Particles 60a of Composite Layer>

The average particle size R1 [μm] of the inorganic particles 60a in the first region can be calculated by the following method.

First, the thickness ratio of the first region 61, which is a fixed ratio calculated in <Measurement Relating to Thickness Ratio of First Region and Second Region> described above, is applied to each cross-section imaged by the SEM. That is, the thickness 61t of the first region 61 and the thickness 62t of the second region 62 calculated in <Measurement Relating to Thickness Ratio of First Region and Second Region> are fixed, and the average particle size of the inorganic particles in each of the fixed regions is calculated.

Next, with respect to the first region 61 of the SEM image binarized by the method described above in (Binarization of SEM Image), spherical or roughly spherical particles having high luminosity are detected, and the average particle size Rp [μm] of one particle, which is the arithmetic average value of the maximum value and the minimum value of the size in one particle, is obtained. The calculation of Rp is performed for all of the particles included in the first region 61. The obtained Rp of each of the all particles is arithmetically averaged to calculate an average particle size R1-1 of the inorganic particles 60a in the first region 61 in one SEM image. The average particle size R1 of the inorganic particles 60a in the first region 61 can be obtained by arithmetically averaging the above-described R1-1 calculated for each SEM image. Calculation for the second region 62 is also performed in a similar manner as in the first region 61 to obtain the average particle size R2.

Furthermore, a relationship of the number of inorganic particles in the first region 61 and the second region 62 of the composite layer 60 will be described.

In the composite layer 60, the number N1 of the inorganic particles 60a having an average particle size of 0.2 μm or more and 3 μm or less in the first region 61 and the number N2 of the inorganic particles 60a having an average particle size of 0.2 μm or more and 3 μm or less in the second region 62 preferably satisfy a relationship of N1>N2. The fact that N2 is smaller than N1 suggests that the second region contains a large amount of particles having an average particle size of 3 μm or more, and in this case, a path through which water in the electrolyte moves in the second region becomes long, and thus the side reaction can be suppressed.

In addition to the relationship between N1 and N2, the ratio N1/N2 of the number N1 of the inorganic particles 60a having an average particle size of 0.2 μm or more and 3 μm or less to the number N2 of the inorganic particles 60a having an average particle size of 0.2 μm or more and 3 μm or less is preferably 1.1 or more and 5.0 or less. In a case where the ratio N1/N2 is 1.1 or more, since the number of particles having an average particle size of 3 μm or more in the second region is larger than that in the first region, a path through which water in the electrolyte moves in the second region becomes long, and the side reaction can be suppressed. When the ratio N1/N2 is 5.0 or less, the number of inorganic particles having an average particle size of 0.2 μm or more and 3 μm or less in the second region becomes 5 or less times when the first region is set as a reference. As a result, the difference in the length of the movement path of Li ions and water in the electrolyte generated in the thickness direction of the composite layer and the concentration distribution of Li are not excessive, and the concentration overvoltage generated in the composite layer is reduced, and thus resistance is low. The ratio N1/N2 is more preferably 1.1 or more and 4.0 or less, and still more preferably 1.5 or more and 3.0 or less.

In the first region 61 and the second region 62, the numbers N1 and N2 of the inorganic particles 60a having an average particle size of 0.2 μm or more and 3 μm or less can be measured, for example, from the cross-sectional SEM image of the electrode structure 70 described above.

### <Measurement of Number N1 and N2 of Inorganic Particles>

First, the thickness ratio of the first region 61, which is a fixed ratio calculated in <Measurement Relating to Thickness Ratio of First Region and Second Region> described above, is applied to each cross-section imaged by the SEM. That is, the thickness 61t of the first region 61 and the thickness 62t of the second region 62 calculated in <Measurement Relating to Thickness Ratio of First Region and Second Region> are fixed, and the number of the inorganic particles in each of the fixed regions is calculated.

On the basis of <Measurement of Average Particle Size of Inorganic Particles 60a of Composite Layer>, the number of particles in which Rp is 0.2 μm or more and 3 μm or less is separately calculated in the first region 61 and the second region 62 from Rp of each of all particles detected in the composite layer. The number of particles in the first region 61 is denoted by N1-1, and the number of particles in the second region 62 is denoted by N2-1. The number N1 and the number N2 to be obtained can be calculated by arithmetically averaging the number N1-1 and the number N2-1 calculated in each SEM image.

Furthermore, an average pore size in the first region 61 and the second region 62 of the composite layer 60 will also be described.

The average pore size P1 in the first region 61 and the average pore size P2 in the second region 62 preferably satisfy a relationship of P1>P2. When P2 is smaller than P1, in the second region, the size of pores when solvent molecules such as water in the electrolyte move toward the electrode 50 is narrowed, and movement of water molecules having a size close to the size of the pores is suppressed, and thus the side reaction can be suppressed.

In addition to the relationship between P1 and P2, the ratio P1/P2 of the average pore size P1 to the average pore size P2 is preferably 1.01 or more and 2.0 or less. When the ratio P1/P2 is 1.01 or more, it is considered that the size of the pores in the second region can be narrowed when the first region is set as a reference, and movement of water molecules having a size close to the size of the pores is suppressed, and thus the side reaction can be suppressed. On the other hand, when the ratio P1/P2 is 2.0 or less, the difference in the length of the movement path of Li ions and water in the electrolyte generated in the thickness direction of the composite layer and the concentration distribution of Li are not excessively, and the concentration overvoltage generated in the composite layer is reduced, and thus resistance is low. A more preferable range of the ratio P1/P2 is 1.05 or more and 1.5 or less, and still more preferably 1.1 or more and 1.2 or less.

The average pore sizes P1 and P2 in the first region 61 and the second region 62 can be measured, for example, from the cross-sectional SEM image of the electrode structure 70 described above.

### <Measurement of Pore Sizes P1 and P2 Included in First Region and Second Region>

First, the thickness ratio of the first region 61, which is a fixed ratio calculated in <Measurement Relating to Thickness Ratio of First Region and Second Region> described above, is applied to each cross-section imaged by the SEM. That is, the thickness 61t of the first region 61 and the thickness 62t of the second region 62 calculated in <Measurement Relating to Thickness Ratio of First Region and Second Region> are fixed, and the pore size in each of the fixed regions is calculated.

The SEM image described in (Observation of Cross-Section of Electrode Structure) of <Measurement Relating to Thickness Ratio of First Region and Second Region> is used. With respect to the SEM image, the solid particles and the binder are displayed to be white and voids are displayed to be black by a binarization treatment using luminosity of a median value between luminosity of the resin and luminosity of the interface between the composite layer 60 and the active material-containing layer as a threshold value. After extracting the black void portion with respect to the first region 61 of the obtained image, a pore size in the void portion is calculated by a sphere arrangement method. That is, a plurality of virtual spheres are applied to the void portion under a constraint condition that diameters of respective spheres become maximum, and a value obtained by arithmetically averaging the diameters of the spheres is set as a pore size P₁₋₁. The pore size P₁₋₁ is calculated in each SEM image, and an arithmetic average thereof is set as the pore size P1 desired to be obtained. A pore size P2 in the second region is calculated by applying the above-described calculation also to the second region.

A porosity of the composite layer 60 is 0.10% or more and 4.0% or less. When the porosity of the composite layer 60 is 4.0% or less, the composite layer 60 becomes dense, movement of solvent molecules such as water moving in the composite layer is delayed, and an electrolysis reaction of water as the side reaction can be suppressed. When the porosity of the composite layer 60 is 0.10% or more, the movement of solvent molecules such as water moving in the composite layer is sufficiently fast, and resistance is low. The porosity of the composite layer 60 is preferably 0.20% or more and 2.0% or less. In addition, the porosity is more preferably 0.60% or more and 1.0% or less.

The porosity of the composite layer 60 can be measured, for example, as follows.

### <Measurement of Porosity>

First, the thickness ratio of the first region 61, which is a fixed ratio calculated in <Measurement Relating to Thickness Ratio of First Region and Second Region> described above, is applied to each cross-section imaged by the SEM. That is, the thickness 61t of the first region 61 and the thickness 62t of the second region 62 calculated in <Measurement Relating to Thickness Ratio of First Region and Second Region> are fixed, and the porosity in each of the fixed regions is calculated.

The SEM image described in (Observation of Cross-Section of Electrode Structure) of <Measurement Relating to Thickness Ratio of First Region and Second Region> is used. With respect to the SEM image, the solid particles and the binder are displayed to be white and voids are displayed to be black by a binarization treatment using luminosity between luminosity of the resin and luminosity of the interface between the composite layer 60 and the active material-containing layer as a threshold value. A result obtained by calculating a ratio of the number of black pixels corresponding to voids to the number of all pixels in the SEM image is calculated as the porosity.

Hereinafter, details of the electrode structure according to an embodiment will be described.

### (Electrode)

An electrode includes a current collector, and an active material-containing layer supported on one surface or both surfaces of the current collector and containing an active material, and a conductive agent and a binder as necessary. The electrode included in the electrode structure in this embodiment can function as a positive electrode or a negative electrode. The electrode included in the electrode structure according to this embodiment preferably functions as the negative electrode. In this section, a case where the electrode functions as the negative electrode will be described.

The current collector is preferably made of, for example, copper, nickel, stainless steel, or aluminum, or an aluminum alloy containing one or more elements selected from the group consisting of Mg, Ti, Zn, Mn, Fe, Cu, and Si. The thickness of the current collector is preferably 5 μm to 20 μm (5 μm or more and 20 μm or less. Same as below). The current collector having such a thickness can balance strength and reduction in weight of the electrode.

In addition, the current collector may include a portion where the active material-containing layer is not provided on the surface thereof. This portion can act as a current collecting tab. Alternatively, a current collecting tab separate from the current collector may be electrically connected to the negative electrode or the positive electrode. When the active material-containing layer is disposed on each of both main surfaces of the current collector, at least a part of one main surface of the current collector may include a portion that is not in contact with the active material-containing layer at that portion. For example, the current collecting tab separate from the current collector can be connected to the portion.

The active material-containing layer contains an active material and, if necessary, a conductive agent and a binder. The active material-containing layer desirably contains, as an active material, a negative electrode active material containing a compound having a lithium ion insertion/extraction potential of 1 V to 3 V (vs. Li/Li⁺) with respect to an oxidation/reduction potential of lithium.

In an aqueous electrolyte battery including a negative electrode containing a compound having a lithium ion insertion/extraction potential within the above-described range in the negative electrode active material, water contained in a solvent of the aqueous electrolyte can be electrolyzed inside the negative electrode and in the vicinity of the negative electrode at the time of initial charge. This is because lithium ions are inserted into the negative electrode active material at the time of initial charge, and the potential of the negative electrode decreases. When the negative electrode potential is lower than a hydrogen generation potential, a part of water is decomposed into hydrogen (H₂) and hydroxide ions (OH⁻) inside the negative electrode and in the vicinity of the negative electrode. This increases pH of the aqueous electrolyte existing inside the negative electrode and in the vicinity of the negative electrode.

The hydrogen generation potential at the negative electrode depends on the pH of the aqueous electrolyte. That is, when the pH of the aqueous electrolyte in contact with the negative electrode increases, the hydrogen generation potential at the negative electrode decreases. In the battery using the negative electrode active material in which the lower limit value of the lithium ion insertion/extraction potential is 1 V or more (vs. Li/Li⁺), the potential of the negative electrode is lower than the hydrogen generation potential at the time of initial charge, but the potential of the negative electrode is likely to be higher than the hydrogen generation potential after the initial charge, and thus water decomposition in the negative electrode is less likely to occur.

Examples of the compound having a lithium ion insertion/extraction potential of 1 V to 3 V (vs. Li/Li⁺) as a potential based on the oxidation/reduction potential of lithium include a titanium oxide and a titanium-containing oxide. Examples of the titanium-containing oxide include a lithium-titanium composite oxide, a niobium-titanium composite oxide, and a sodium-niobium-titanium composite oxide. The negative electrode active material may contain one or more of the titanium oxide and the titanium-containing oxide.

The titanium oxide includes, for example, a titanium oxide having a monoclinic structure, a titanium oxide having a rutile structure, and a titanium oxide having an anatase structure. In the titanium oxide having each crystal structure, the composition before charge can be expressed by TiO₂, and the composition after charge can be expressed by Li_{y}TiO₂ (subscript y is in a range of 0≤y≤1). In addition, the structure of the titanium oxide having the monoclinic structure before charge can be expressed by TiO₂ (B).

The lithium titanium oxide includes, for example, a lithium-titanium oxide having a spinel structure (for example, a compound that is expressed by a general formula Li₄₊ₓTi₅O₁₂ and satisfies a relationship of −1≤x≤3), a lithium-titanium oxide having a ramsdellite structure (for example, a compound that is expressed by Li₂₊ₓTi₃O₇ and satisfies a relationship of −1≤x≤3), a compound that is expressed by Li_{1+y}Ti₂O₄ and satisfies a relationship of 0≤y≤1, a compound that is expressed by Li_{1.1+y}Ti_{1.8}O₄ and satisfies a relationship of 0≤y≤1, a compound that is expressed by Li_{1.07+y}Ti_{1.86}O₄ and satisfies a relationship of 0≤y≤1, a compound that is expressed by Li₂TiO₂ and satisfies a relationship of 0<z≤1, and the like. In addition, the lithium-titanium oxide may be a lithium-titanium composite oxide into which a different element is introduced.

The niobium-titanium composite oxide includes, for example, a compound that is expressed by LiₐTiMe_{b}Nb_{2±c}O_{7±σ}, in which relationships of 0≤a≤5, 0≤b≤0.3, 0≤c≤0.3, 0≤σ≤0.3, and Me is one or more selected from the group consisting of Fe, V, Mo, and Ta.

The sodium niobium titanium composite oxide includes, for example, an orthorhombic Na-containing niobium-titanium composite oxide expressed by a general formula Li_{2+d}Na₂₋ₑMe1_{f}Ti_{6-g-h}Nb_{g}Me2ₕO_{14+δ} in which relationships of 0≤d≤4, 0≤e<2, 0≤f<2, 0<g<6, 0≤h<3, g+h<6, −0.5≤δ≤0.5 are satisfied, Me1 includes one or more selected from Cs, K, Sr, Ba, and Ca, and Me2 includes one or more selected from Zr, Sn, V, Ta, Mo, W, Fe, Co, Mn, and Al.

As the negative electrode active material, a titanium oxide having an anatase structure, a titanium oxide having a monoclinic structure, a lithium-titanium oxide having a spinel structure, a niobium-titanium composite oxide, or a mixture thereof is preferably used. On the other hand, when the titanium oxide having an anatase structure, the titanium oxide having a monoclinic structure, or the lithium-titanium oxide having a spinel structure is used as the negative electrode active material, for example, a high electromotive force can be obtained by combining with a positive electrode using a lithium-manganese composite oxide as a positive electrode active material. On the other hand, when the niobium-titanium composite oxide is used, high capacity can be exhibited.

The negative electrode active material can be contained in the active material-containing layer, for example, in a form of particles. The negative electrode active material particles may be primary particles, secondary particles that are aggregates of the primary particles, or a mixture of a single primary particle and a secondary particle. A shape of particles is not particularly limited, and may be, for example, a spherical shape, an elliptical shape, a flat shape, a fibrous shape, or the like.

The secondary particles of the negative electrode active material can be obtained, for example, by the following method. First, active material raw materials are reacted and synthesized to prepare an active material precursor having an average particle size of 1 μm or less. Thereafter, a firing treatment is performed on the active material precursor, and a pulverization treatment is performed by using a pulverizer such as a ball mill and a jet mill. Next, in the firing treatment, the active material precursor is aggregated and grows into a secondary particle having a large particle size.

The average particle size (diameter) of the secondary particles of the negative electrode active material is preferably 3 μm or more, and more preferably 5 μm to 20 μm. When the average particle size is within this range, since a surface area of the active material is small, decomposition of water can be further suppressed.

The average particle size of the primary particles of the negative electrode active material is desirably 1 μm or less. As a result, a diffusion distance of Li ions inside the active material is shortened, and a specific surface area is increased. Therefore, excellent high input performance (rapid charge) can be obtained. On the other hand, when the average particle size of the primary particles of the negative electrode active material is small, aggregation of the particles is likely to occur. When the particles of the negative electrode active material are aggregated, the aqueous electrolyte is likely to be unevenly distributed to the negative electrode in the secondary battery, which may lead to depletion of ion species in the counter electrode. Therefore, the average particle size of the primary particles of the negative electrode active material is preferably 0.001 μm or more. The average particle size of the primary particles of the negative electrode active material is more preferably 0.1 μm to 0.8 μm.

The primary particle size and the secondary particle size represent a particle size at which a volume integrated value is 50% in a particle size distribution obtained by a laser diffraction particle size distribution measuring apparatus. As the laser diffraction particle size distribution measuring apparatus, for example, Shimadzu SALD-300 is used. In the measurement, a luminous intensity distribution is measured 64 times at intervals of 2 seconds. As a sample for the particle size distribution measurement, a dispersion solution which is diluted with N-methyl-2 pyrrolidone so that the concentration of the active material particles is 0.1 mass % to 1 mass % is used. Alternatively, as the measurement sample, a sample obtained by dispersing 0.1 g of active material in 1 ml to 2 ml of distilled water containing a surfactant is used.

In the negative electrode active material, a specific surface area in a BET method by nitrogen (N₂) adsorption is within a range of, for example, 3 m²/g to 200 m²/g. When the specific surface area of the negative electrode active material is within the range, affinity between the negative electrode and the aqueous electrolyte can be further increased.

The specific surface area of the negative electrode active material-containing layer in the BET method by nitrogen (N₂) adsorption is more preferably 3 m²/g to 50 m²/g. When the specific surface area of the negative electrode active material-containing layer is 3 m²/g or more, the affinity between the negative electrode active material and the aqueous electrolyte becomes satisfactory. As a result, interface resistance of the negative electrode is suppressed, and an output performance and a charge and discharge cycle performance of the secondary battery can be maintained to be high. When the specific surface area of the negative electrode active material-containing layer is kept at 50 m²/g or less, the distribution of ion species ionized from an electrolyte salt contained in the aqueous electrolyte is not biased to the negative electrode, and deficiency of the ion species in the positive electrode can be prevented and the output performance and the charge and discharge cycle performance can be maintained to be high.

The specific surface area can be determined, for example, by the following method. In a case where the electrode including the active material-containing layer to be measured is incorporated in the secondary battery, the secondary battery is disassembled to collect a part of the active material-containing layer. In a nitrogen gas kept at 77 K (boiling point of nitrogen), a nitrogen gas adsorption amount (mL/g) of a sample is measured for each pressure P while gradually increasing a pressure P (mmHg) of the nitrogen gas. A value obtained by dividing the pressure P (mmHg) by a saturated vapor pressure P₀ (mmHg) of the nitrogen gas is set as a relative pressure P/P₀, and the nitrogen gas adsorption amount with respect to each relative pressure P/P₀ is plotted to obtain an adsorption isotherm. A BET plot is calculated from the nitrogen adsorption isotherm and a BET equation, and a specific surface area is obtained by using the BET plot. Note that, the BET plot is calculated by a BET multipoint method.

The conductive agent is blended as necessary in order to enhance a current collection performance and suppress contact resistance between the negative electrode active material and the current collector. Examples of the conductive agent include carbonaceous materials such as acetylene black, Ketjen black, graphite, and coke. The conductive agent may be used alone or in combination of two or more kinds thereof.

The binder has an operation of binding the negative electrode active material and the conductive agent. As the binder, for example, at least one selected from the group consisting of cellulose-based polymers such as polytetrafluoroethylene (PTFE), polyvinylidene fluoride (PVdF), and carboxymethyl cellulose (CMC), a fluorine-based rubber, a styrene-butadiene rubber, an acrylic resin, or a copolymer thereof, polyacrylic acid, and polyacrylonitrile can be used, but the binder is not limited thereto.

Blending ratios of the negative electrode active material, the conductive agent, and the binder in the negative electrode active material-containing layer are preferably in ranges of 70 mass % to 95 mass %, 3 mass % to 20 mass %, and 2 mass % to 10 mass %, respectively. When the blending ratio of the conductive agent is 3 mass % or more, conductivity of the active material-containing layer can be satisfactory, and when the blending ratio is 20 mass % or less, decomposition of the aqueous electrolyte on the surface of the conductive agent can be reduced. When the blending ratio of the binder is 2 mass % or more, sufficient electrode strength is obtained. Since the binder is a material exhibiting electrical insulation, when the blending ratio is 10 mass % or less, an insulating portion in the electrode can be reduced.

### (Electrolyte)

The electrode structure can further include an electrolyte. The electrolyte may be an aqueous electrolyte and a nonaqueous electrolyte. Hereinafter, examples that can be used as an aqueous electrolyte and a non-aqueous electrolyte will be described.

First, the aqueous electrolyte contains an aqueous solvent and an electrolyte salt. The aqueous electrolyte is, for example, a liquid. The liquid aqueous electrolyte is an aqueous solution prepared by dissolving an electrolyte salt as a solute in an aqueous solvent. In a case where the aqueous electrolyte is held in both the negative electrode active material-containing layer and the positive electrode active material-containing layer, types of the aqueous electrolytes may be the same or different.

In the aqueous solution, the amount of the aqueous solvent is 1 mole or more, and more preferably 3.5 moles or more on the basis of 1 mole of the salt serving as a solute.

As the aqueous solvent, a solution containing water can be used. The solution containing water may be pure water or a mixed solvent of water and an organic solvent. The aqueous solvent contains, for example, water in a proportion of 50 vol % or more.

Whether or not water is contained in the electrolyte can be confirmed by gas chromatography-mass spectrometry (GC-MS) measurement. In addition, calculation of a concentration of a salt and the content of water in the electrolyte can be performed by, for example, inductively coupled plasma (ICP) emission spectrometry. A molar concentration (mol/L) can be calculated by weighing a specified amount of the electrolyte and calculating a concentration of a contained salt. In addition, the number of moles of the solute and the solvent can be calculated by measuring specific gravity of the electrolyte.

The aqueous electrolyte may be a gel electrolyte. The gel electrolyte is prepared by mixing and combining the above-described liquid aqueous electrolyte and a polymer compound. Examples of the polymer compound include PVdF, polyacrylonitrile (PAN), polyethylene oxide (PEO), and the like.

As the electrolyte salt, for example, a lithium salt, a sodium salt, or a mixture thereof can be used. As the electrolyte salt, one kind or two or more kinds can be used.

As the lithium salt, for example, lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), and lithium bis(trifluoromethanesulfonyl)imide (LiTFSI; LiN (SO₂CF₃)₂), lithium bis(fluorosulfonyl) imide (LiFSI; LiN (SO₂F)₂), lithium bisoxalate borate (LiBOB: LiB [(OCO)₂]₂), and the like can be used.

The lithium salt preferably contains LiCl. When LiCl is used, a concentration of the lithium ions in the aqueous electrolyte can be increased. In addition, the lithium salt preferably includes at least one of LiSO₄ and LiOH in addition to LiCl.

As the sodium salt, sodium chloride (NaCl), sodium sulfate (Na₂SO₄), sodium hydroxide (NaOH), sodium nitrate (NaNO₃), sodium trifluoromethanesulfonylamide (NaTESA), and the like can be used.

The molar concentration of alkali metal ions (for example, lithium ions) in the aqueous electrolyte may be 3 mol/L or more, 6 mol/L or more, or 12 mol/L or more. According to one example, the molar concentration of the alkali metal ions in the aqueous electrolyte is 14 mol/L or less. When the concentration of the alkali metal ions in the aqueous electrolyte is high, electrolysis of water as a side reaction in the negative electrode is likely to be suppressed, and hydrogen generation from the negative electrode tends to be small.

The aqueous electrolyte preferably contains at least one selected from a chlorine ion (Cl⁻), a hydroxide ion (OH⁻), a sulfate ion (SO₄²⁻), and a nitrate ion (NO³⁻) as anion species.

pH of the aqueous electrolyte is preferably 3 to 14, and more preferably 4 to 13. When separate electrolytes are used for the negative electrode side electrolyte and the positive electrode side electrolyte, the pH of the negative electrode side electrolyte is preferably in a range of 3 to 14, and the pH of the positive electrode side electrolyte is preferably in a range of 1 to 8.

When the pH of the negative electrode side electrolyte is within the above-described range, the hydrogen generation potential at the negative electrode decreases, and thus hydrogen generation at the negative electrode is suppressed. According to this, a storage performance and a cycle life performance of the battery are improved. When the pH of the positive electrode side electrolyte is within the above-described range, the oxygen generation potential at the positive electrode increases, and thus the oxygen generation at the positive electrode decreases. According to this, a storage performance and a cycle life performance of the battery are improved. The pH of the positive electrode side electrolyte is more preferably in a range of 3 to 7.5.

The aqueous electrolyte may contain a surfactant. Examples of the surfactant include nonionic surfactants such as polyoxyalkylene alkyl ether, polyethylene glycol, polyvinyl alcohol, thiourea, 3,3′-dithiobis(1-propanephonic acid) disodium, dimercaptothiadiazole, boric acid, oxalic acid, malonic acid, saccharin, sodium naphthalene sulfonate, gelatin, potassium nitrate, aromatic aldehyde, and heterocyclic aldehyde. The surfactant may be used alone or in combination of two or more kinds thereof.

The pH of the aqueous electrolyte is preferably different between the negative electrode side and the positive electrode side after initial charge. In the secondary battery after the initial charge, the pH of a first aqueous electrolyte on the negative electrode side is preferably 3 or more, more preferably 5 or more, and still more preferably 7 or more. In the secondary battery after the initial charge, the pH of a third aqueous electrolyte on the positive electrode side is preferably in a range of 0 to 7, and more preferably in a range of 0 to 6.

The pH of the aqueous electrolytes on the negative electrode side and the positive electrode side can be obtained, for example, by disassembling the secondary battery and measuring the pH of the aqueous electrolyte existing between the composite layer and each of the negative electrode and the positive electrode.

As the electrolyte, a liquid nonaqueous electrolyte or a gel nonaqueous electrolyte can be used other than the aqueous electrolyte. The liquid nonaqueous electrolyte is prepared by dissolving an electrolyte salt as a solute in an organic solvent.

Examples of the electrolyte salt include lithium salts such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate lithium (LiCF₃SO₃), bistrifluoromethylsulfonylimide (LiN (CF₃SO₂)₂), and lithium bis(fluorosulfonyl) imide (LiN (SO₂F)₂; LiFSI), and mixtures thereof.

Examples of the organic solvent include cyclic carbonates such as propylene carbonate (PC), ethylene carbonate (EC), and vinylene carbonate (VC); chain carbonates such as diethyl carbonate (DEC), dimethyl carbonate (DMC), and methyl ethyl carbonate (MEC); cyclic ethers such as tetrahydrofuran (THE), 2-methyl tetrahydrofuran (2MeTHF), and dioxolane (DOX); chain ethers such as dimethoxyethane (DME), and diethoxyethane (DEE); Y-butyrolactone (GBL), acetonitrile (AN), and sulfolane (SL).

These organic solvents can be used alone or as a mixed solvent.

The gel nonaqueous electrolyte is prepared by combining a liquid nonaqueous electrolyte and a polymer material. Examples of the polymer material include PVdF, PAN, PEO, or mixtures thereof.

Alternatively, as the nonaqueous electrolyte, other than the liquid nonaqueous electrolyte and the gel nonaqueous electrolyte, a normal temperature molten salt (ionic melt) containing lithium ions, a polymer solid electrolyte, an inorganic solid electrolyte, or the like may be used.

The normal temperature molten salt (ionic melt) represents a compound that can exist as a liquid at normal temperature (15° C. to 25° C.) among organic salts composed of a combination of organic cations and anions. The normal temperature molten salt includes a normal temperature molten salt that exists as a liquid alone, a normal temperature molten salt that becomes a liquid after being mixed with an electrolyte salt, a normal temperature molten salt that becomes a liquid after being dissolved in an organic solvent, or a mixture thereof. In general, the normal temperature molten salt used in the secondary battery has a melting point of 25° C. or lower. In addition, the organic cations generally have a quaternary ammonium skeleton.

### (Composite Layer)

The composite layer is provided on the active material-containing layer, and in the secondary battery including the electrode structure according to this embodiment to be described later, the composite layer exists between the positive electrode and the negative electrode and has a function as a separator. For example, in the electrode in which the active material-containing layer is supported on both surfaces of the current collector, the composite layer may be provided on a main surface of one active material-containing layer, or may be provided on main surfaces of both active material-containing layers.

The composite layer contains inorganic particles. Examples of the inorganic particles contained in the composite layer include oxide-based ceramics such as alumina, silica, zirconia, yttria, magnesium oxide, calcium oxide, barium oxide, strontium oxide, and vanadium oxide; carbonates and sulfates such as sodium carbonate, potassium carbonate, magnesium carbonate, calcium carbonate, barium carbonate, lanthanum carbonate, cerium carbonate, calcium sulfate, magnesium sulfate, aluminum sulfate, gypsum, and barium sulfate; phosphates such as hydroxyapatite, lithium phosphate, zirconium phosphate, and titanium phosphate; and nitride-based ceramics such as silicon nitride, titanium nitride, and boron nitride. The inorganic particles described above may take a form of a hydrate.

The inorganic particles preferably include solid electrolyte particles having ion conductivity of alkali metal ions. Specifically, inorganic solid particles having ion conductivity for lithium ions and sodium ions are more preferable.

Examples of the inorganic solid particles having lithium ion conductivity include an oxide-based solid electrolyte and a sulfide-based solid electrolyte. As the oxide-based solid electrolyte, a lithium phosphate solid electrolyte that has a NASICON (Sodium (Na) Super Ionic Conductor)-type structure and is expressed by a general formula of Li₁₊ᵤM₂ (PO₄)₃ is preferably used. M in the general formula is, for example, one or more selected from the group consisting of titanium (Ti), germanium (Ge), strontium (Sr), zirconium (Zr), tin (Sn), aluminum (Al), and calcium (Ca). The subscript x is within a range of 0≤u≤2. The ionic conductivity of the lithium phosphate solid electrolyte expressed by the general formula of LiM₂ (PO₄)₃ is, for example, 1×10⁻⁵ S/cm to 1×10⁻³ S/cm.

Specific examples of the lithium phosphate solid electrolyte having the NASICON-type structure include a LATP compound that is expressed by Li₁₊ᵥAlᵥTi₂₋ᵥ (PO₄)₃ and satisfies a relationship of 0.1≤v≤0.5; a compound which is expressed by Li_{1+y}AlwM1_{2-w} (PO₄)₃ and in which M1 is one or more selected from the group consisting of Ti, Ge, Sr, Zr, Sn, and Ca, and relationships of 0≤y≤1 and 0≤w≤1 are satisfied; a compound that is expressed by Li₁₊ᵤAlᵤGe₂₋ᵤ (PO₄)₃ and satisfies a relationship of 0≤u≤2; a compound that is expressed by Li₁₊ᵤAlᵤZr₂₋ᵤ (PO₄)₃ and satisfies a relationship of 0≤u≤2; a compound that is expressed by Li_{1+p+q}AlₚMα₂₋ₚSi_{q}P_{3-q}O₁₂ and in which Ma is one or more selected from the group consisting of Ti and Ge, relationships of 0<p≤2, and 0≤q<3 are satisfied; and a compound that is expressed by Li₁₊₂ₘZr₁Caₘ (PO₄)₃ and satisfies a relationship of 0≤m<1. Li₁₊₂ₘZr₁₋ₘCaₘ (PO₄)₃ is preferably used as the inorganic solid electrolyte particles because water resistance is high, and reducibility and the cost are low.

In addition to the lithium phosphate solid electrolytes, examples of the oxide-based solid electrolyte include an amorphous LIPON compound that is expressed by LiᵣPOₛNₜ and satisfies relationships of 2.6≤r≤3.5, 1.9≤s≤3.8, and 0.1≤t≤1.3 (for example, Li_{2.9}PO_{3.3}N_{0.46}); a compound which is expressed by La₅₊ₗAₗLa₃₋ₗMβ₂O₁₂ having a garnet type structure and in which A is one or more selected from the group consisting of Ca, Sr, and Ba, Mβ is one or more selected from the group consisting of Nb and Ta, and a relationship of 0≤l≤0.5 is satisfied; a compound which is expressed by Li₃Mγ₂₋ₗL₂O₁₂ and in which Mγ is one or more selected from the group consisting of Ta and Nb, L may contain Zr, and a relationship of 0≤l≤0.5 is satisfied; a compound that is expressed by Li₇₋₃ₗAlₗLa₃Zr₃O₁₂ and satisfies a relationship of 0≤l≤0.5; an LLZ compound which is expressed by Li₅₊ᵤLa₃M2₂₋ᵤZrᵤO₁₂ and in which M2 is one or more selected from the group consisting of Nb and Ta, and a relationship of 0≤u≤2 is satisfied (for example, Li₇La₃Zr₂O₁₂); and a compound that is expressed by La_{2/3-χ}Li_{χ}TiO₃ having a perovskite type structure and satisfies a relationship of 0.3≤χ≤0.7. The solid electrolyte may be used alone or in combination of two or more kinds thereof. The ion conductivity of LIPON is, for example, 1×10⁻⁶ S/cm to 5×10⁻⁶ S/cm. The ion conductivity of LLZ is, for example, 1×10⁻⁴ S/cm to 5×10⁻⁴ S/cm.

As the inorganic solid particles having ion conductivity of sodium ions, a sodium-containing solid electrolyte may be used. The sodium-containing solid electrolyte is excellent in ion conductivity of sodium ions. Examples of the sodium-containing solid electrolyte include sodium phosphorus sulfide and sodium phosphorus oxide. The sodium ion-containing solid electrolyte is preferably in a form of glass ceramics.

The inorganic solid particles are preferably a solid electrolyte having a lithium ion conductivity of 1×10⁻⁵ S/cm or more at 25° C.

The shape of the inorganic solid particles is not particularly limited, and can be, for example, a spherical shape, an elliptical shape, a flat shape, a fibrous shape, or the like.

The average particle size of the inorganic solid particles is preferably 15 μm or less, and more preferably 12 μm or less. When the average particle size of the inorganic solid particles is small, denseness of the composite layer can be enhanced.

The average particle size of the inorganic solid particles is preferably 0.01 μm or more, and more preferably 0.1 μm or more. When the average particle size of the inorganic solid particles is large, aggregation of particles tends to be suppressed.

In the composite layer, the inorganic solid particles are preferably a main component. A proportion of the inorganic solid particles in the composite layer is preferably 70 mass % or more, more preferably 80 mass % or more, and still more preferably 85 mass % or more from the viewpoint of enhancing the ion conductivity of the composite layer. The proportion of the inorganic solid particles in the composite layer is preferably 95 mass % or less, and more preferably 90 mass % or less from the viewpoint of increasing the membrane strength of the composite layer. The proportion of the inorganic solid particles in the composite layer can be calculated by thermogravimetric (TG) analysis.

The composite layer may contain a polymer material in addition to the inorganic particles. The polymer material contained in the composite layer enhances a binding property between the inorganic solid particles. A weight-average molecular weight of the polymer material is, for example, 3000 or more. When the weight-average molecular weight of the polymer material is 3000 or more, the binding property of the inorganic solid particles is further enhanced. The weight-average molecular weight of the polymer material is preferably 3000 to 5000000, more preferably 5000 to 2000000, and still more preferably 10000 to 1000000. The weight-average molecular weight of the polymer material can be determined by gel permeation chromatography (GPC).

The polymer material may be a polymer composed of a single monomer unit, a copolymer composed of a plurality of monomer units, or a mixture thereof. The polymer material preferably contains a monomer unit composed of hydrocarbon having a functional group containing one or more selected from the group consisting of oxygen (O), sulfur(S), nitrogen (N), and fluorine (F). In the polymer material, a proportion occupied by a portion composed of monomer units is preferably 70 mol % or more. Hereinafter, this monomer unit is referred to as a first monomer unit. In addition, in a copolymer, a monomer unit other than the first monomer unit is referred to as a second monomer unit. The copolymer of the first monomer unit and the second monomer unit may be an alternating copolymer, a random copolymer, or a block copolymer.

In the polymer material, when the proportion occupied by the portion composed of the first monomer unit is lower than 70 mol %, there is a concern that a water barrier property of the composite layer may be deteriorated. In the polymer material, the proportion of the portion composed of the first monomer unit is preferably 90 mol % or more. The polymer material is most preferably a polymer in which the proportion of the portion composed of the first monomer unit is 100 mol %, that is, a polymer composed of only the first monomer unit.

The first monomer unit may be a compound having a functional group containing one or more elements selected from the group consisting of oxygen (O), sulfur(S), nitrogen (N), and fluorine (F) in a side chain, and having a main chain composed of a carbon-carbon bond. The hydrocarbon may have one or more functional groups containing one or more elements selected from the group consisting of oxygen (O), sulfur(S), nitrogen (N), and fluorine (F). The functional group in the first monomer unit enhances conductivity of alkali metal ions passing through the composite layer.

The hydrocarbon constituting the first monomer unit preferably has a functional group containing one or more selected from the group consisting of oxygen (O), sulfur(S), and nitrogen (N). When the first monomer unit has such a functional group, the conductivity of alkali metal ions in the composite layer tends to be further enhanced and internal resistance tends to be reduced.

The first monomer unit preferably has one or more selected from the group consisting of a formal group, a butyral group, a carboxymethyl ester group, an acetyl group, a carbonyl group, a hydroxyl group, and a fluoro group as the functional group. In addition, the first monomer unit more preferably has at least one of a carbonyl group and a hydroxyl group as the functional group, and still more preferably both the carbonyl group and the hydroxyl group.

The first monomer unit can be represented by the following formula.

[symbol]

CR₁R₂·CR₁R₂ [symbol] ₙ [Chemical Formula 1]

In the above-described formula, R₁ is preferably selected from the group consisting of hydrogen (H), an alkyl group, and an amino group. In addition, R₂ is preferably selected from the group consisting of hydroxyl group (—OH), —OR₁, —COOR₁, —OCOR₁, —OCH (R₁) O—, —CN, —N(R₁)₃, and —SO₂R₁.

Examples of the first monomer unit include one or more selected from the group consisting of vinyl formal, vinyl alcohol, vinyl acetate, vinyl acetal, vinyl butyral, acrylic acid and derivatives thereof, methacrylic acid and derivatives thereof, acrylonitrile, acrylamide and derivatives thereof, styrene sulfonic acid, polyvinylidene fluoride, and tetrafluoroethylene.

The polymer material preferably contains one or more selected from the group consisting of polyvinyl formal, polyvinyl alcohol (PVA), polyvinyl acetal, polyvinyl butyral (PVB), polymethyl methacrylate, PVdF, PTFE, fluororubber, styrene-butadiene rubber, polyacrylic acid compounds, imide compounds, and CMC.

Hereinafter, an example of a structural formula of a compound that can be used as the polymer material will be described.

A structural formula of polyvinyl formal is as follows. In the following formula, a is preferably 50 to 80, b is preferably 0 to 5, and c is preferably 15 to 50.

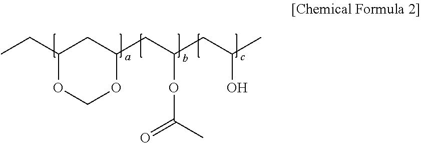

A structural formula of polyvinyl butyral is as follows. In the following formula, l is preferably 50 to 80, m is preferably 0 to 10, and n is preferably 10 to 50.

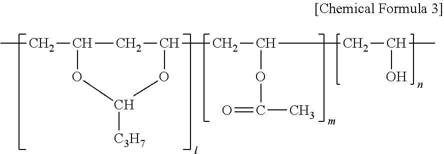

A structural formula of polyvinyl alcohol is as follows. In the following formula, n is preferably 70 to 20000.

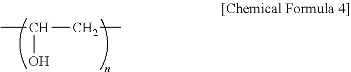

A structural formula of polymethyl methacrylate is as follows. In the following formula, n is preferably 30 to 10000.

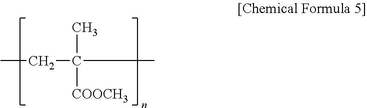

The second monomer unit does not have a compound other than the first monomer unit, that is, a functional group containing one or more selected from the group consisting of oxygen (O), sulfur(S), nitrogen (N), and fluorine (F), or does not have a hydrocarbon even if having this functional group.

Examples of the second monomer unit include ethylene oxide and styrene. Examples of the polymer composed of the second monomer unit include polyethylene oxide (PEO) and polystyrene (PS).

The types of functional groups contained in the first monomer unit and the second monomer unit can be identified by infrared (Fourier spectroscopy Transform Infrared Spectroscopy; FT-IR). In addition, the configuration in which the first monomer unit is composed of hydrocarbon can be determined by nuclear magnetic resonance (NMR). In addition, in the copolymer of the first monomer unit and the second monomer unit, the proportion occupied by the portion composed of the first monomer unit can be calculated by NMR.

The polymer material may contain an aqueous electrolyte. A proportion of the aqueous electrolyte that can be contained in the polymer material can be grasped from a water absorption rate. Here, the water absorption rate of the polymer material is a value ([M_{p′}−Mₚ]/Mₚ×100) obtained by dividing a value obtained by subtracting the mass Mₚ Of the polymer material before immersion from the mass M_{p′} Of the polymer material after immersion in water kept at a temperature of 23° C. for 24 hours by the mass Mₚ of the polymer material before immersion. The water absorption rate of the polymer material is considered to be related to polarity of the polymer material.

When using a polymer material having a high water absorption rate, alkali metal ion conductivity of the composite layer tends to be increased. In addition, when using the polymer material having a high water absorption rate, since a binding force between the inorganic solid particles and the polymer material is enhanced, flexibility of the composite layer can be enhanced. The water absorption rate of the polymer material is preferably 0.01% or more, more preferably 0.5% or more, and still more preferably 2% or more.

When using a polymer material having a low water absorption rate, the strength of the composite layer can be increased. That is, when the water absorption rate of the polymer material is excessively high, the composite layer may be swollen by the aqueous electrolyte. In addition, when the water absorption rate of the polymer material is excessively high, the polymer material in the composite layer may flow out into the aqueous electrolyte. The water absorption rate of the polymer material is preferably 15% or less, more preferably 10% or less, still more preferably 7% or less, and particularly preferably 3% or less.

The proportion of the polymer material in the composite layer is preferably 5 mass % or more, and more preferably 10 mass % or more from the viewpoint of enhancing the flexibility of the composite layer. In addition, the denseness of the composite layer tends to be higher as the proportion of the polymer material is higher.

In addition, the proportion of the polymer material in the composite layer is preferably 30 mass % or less, more preferably 20 mass % or less, and still more preferably 10 mass % or less from the viewpoint of enhancing the ion conductivity of the composite layer. The proportion of the polymer material in the composite layer can be calculated by thermogravimetric (TG) analysis.

The polymer materials contained in the composite layer may be the same as each other or different types of polymer materials may be used. As the polymer material, a single type of polymer material may be used, or a plurality of types of polymer materials may be mixed and used.

The composite layer may contain a plasticizer or an electrolyte salt in addition to the inorganic solid particles and the polymer material. For example, when the composite layer contains the electrolyte salt, the alkali metal ion conductivity of the composite layer can be further enhanced.

The electrode structure according to this embodiment can be manufactured, for example, as follows. First, a current collector is prepared. Next, an active material, a conductive agent, and a binder are suspended in an appropriate solvent to prepare slurry, and the slurry is applied to one side or both sides of the current collector. A coated film on the current collector is dried to form an active material-containing layer. For the purpose of controlling the density of each of the active material-containing layer and the composite layer formed at the subsequent stage, pressing may be performed before forming the composite layer. According to this, an electrode is prepared.

The composite layer is formed on an electrode, for example, as follows.

A slurry is prepared for forming a separator. The slurry for forming a separator layer is obtained by stirring a mixture obtained by mixing inorganic solid particles, a polymer material, and a solvent. In addition, the obtained slurry may be subjected to slurry dispersion by a wet bead mill or the like.

As the solvent, a solvent capable of dissolving a polymer material is preferably used. Examples of the solvent include alcohols such as ethanol, methanol, isopropyl alcohol, normal propyl alcohol, and benzyl alcohol; ketones such as acetone, methyl ethyl ketone, methyl isobutyl ketone, cyclohexanone, and diacetone alcohol; esters such as ethyl acetate, methyl acetate, butyl acetate, ethyl lactate, methyl lactate, and butyl lactate; ethers such as methyl cellosolve, ethyl cellosolve, butyl cellosolve, 1,4-dioxane, and tetrahydrofuran; glycols such as ethylene glycol monoethyl ether acetate, propylene glycol monomethyl ether acetate, butyl carbitol acetate, and ethyl carbitol acetate; glycol ethers such as methyl carbitol, ethyl carbitol, and butyl carbitol; aprotic polar solvents such as dimethylformamide, dimethylacetamide, acetonitrile, valeronitrile, N-methyl-2 pyrrolidone (NMP), N-ethyl-2 pyrrolidone, and γ-butyrolactam; cyclic carboxylic acid esters such as gamma butyrolactone, gamma valerolactone, gamma caprolactone, and epsilon caprolactone; chain carbonate compounds such as dimethyl carbonate, diethyl carbonate, di-n-propyl carbonate, diisopropyl carbonate, n-propyl isopropyl carbonate, ethyl methyl carbonate, and methyl-n-propyl carbonate are used.

With regard to the slurry for forming a separator layer, Slurry 1 and Slurry 2 having different mode diameters are prepared.

For example, Slurry 1 for forming a composite layer is applied onto the active material-containing layer on one main surface of the electrode, for example, by a doctor blade method to obtain a coated film. The coated film is dried at a temperature of 50° C. to 150° C. Next, Slurry 2 for forming a composite layer is applied to the surface of the region coated with Slurry 1 for forming the composite layer to obtain a coated film. The coated film is dried again at a temperature of 50° C. to 150° C. In this way, a laminate to be an electrode structure is obtained. Here, the laminate to be the electrode structure may be pressed immediately before Slurry 2 for forming the composite layer is subsequently applied.

Here, it is possible to perform control such that R1 and R2, which are average particle sizes of the inorganic particles in the first region and the second region, satisfy a relationship of R1<R2 by adjusting the mode diameter of the inorganic particles contained in each of Slurry 1 and Slurry 2. For example, the average particle size of the inorganic particles contained in the second region becomes larger than the average particle size of the inorganic particles contained in the first region, and R2/R1 can be increased by making the mode diameter of the inorganic particles contained in Slurry 2 higher than the mode diameter of the inorganic particles contained in Slurry 1. In addition, by making the coating thickness of Slurry 2 smaller than the coating thickness of Slurry 1, the number of inorganic particles included in the second region can be reduced, and control can be performed so that a relationship of N1>N2 is satisfied. Furthermore, by pressing the obtained electrode structure, the composite layer is crushed, and the porosity can be reduced.

Next, the laminate is subjected to a roll press treatment. In the roll press treatment, for example, a press device including two rollers on upper and lower sides is used. When using such a pressing device, when the coated films are provided on both surfaces of an electrode, both coated films can be simultaneously pressed. At this time, a heating temperature of the roller can be appropriately changed in accordance with a desired structure. For example, the heating temperature of the roller is set to a temperature within a softening point ±20° C. of the polymer material in the coated film. The heating temperature of the roller is preferably lower than the melting point of the polymer material. When the heating temperature is increased to a temperature equal to or higher than the melting point of the polymer material, the polymer material is melted on the surface side of the coated film, and vacancies may be completely lost. The complete loss of vacancies is undesirable because ion conductivity of the composite layer is lowered.

The softening point and the melting point of the polymer material may vary depending on the molecular weight and the unit ratio of the monomer.

According to one example, the softening point of PVdF is 135° C. to 145° C., and the melting point thereof is 170° C. to 180° C. The softening point of polyvinyl formal is 120° C. to 130° C., and the melting point thereof is 190° C. to 200° C. The softening point of polyvinyl butyral is 120° C. to 130° C., and the melting point thereof is 190° C. to 200° C.

In addition, with regard to each electrode, pressing may be performed prior to the application of the slurry for forming the composite layer, and pressing may be performed again after the slurry coated film is dried for the purpose of controlling the density of each of the active material-containing layer and the composite layer.

As described above, an electrode structure in which the average particle size R1 of the inorganic particles in the first region and the average particle size R2 of the inorganic particles in the second region satisfy the relationship of R1<R2 can be obtained.

The electrode structure according to the first embodiment includes the electrode, and the composite layer containing inorganic particles. The composite layer includes the first region and the second region. The first region exists between the electrode and the second region. In a cumulative frequency distribution of the inorganic particles having an average particle size of 3 μm or more in the composite layer with respect to a thickness direction of the composite layer, when the total number of the inorganic particles having the average particle size of 3 μm or more is normalized to 100, and the first region is set to a range in which a cumulative frequency of the inorganic particles having the average particle size of 3 μm or more is 0 or more and less than 25, the first region is 5% or more and 40% or less of the thickness of the composite layer from an interface between the electrode and the composite layer. In the cross-sectional SEM image of the composite layer, the average particle size R1 of the inorganic particles in the first region and the average particle size R2 of the inorganic particles in the second region satisfy a relationship of R1<R2. According to this, in the secondary battery including the electrode structure according to this embodiment, it is possible to suppress an increase in resistance while suppressing electrolysis of water accompanied by a side reaction.

### Second Embodiment

According to a second embodiment, a secondary battery including the electrode structure according to the first embodiment and a counter electrode is provided.

Hereinafter, a configuration of the secondary battery according to this embodiment will be described, but since the electrode structure has been described in the first embodiment, description thereof will be omitted.

### (Counter Electrode)

In the first embodiment, since a case where the electrode of the electrode structure is a negative electrode has been described, a case where the counter electrode is a positive electrode will be described here. As described above, since the active material-containing layer included in the electrode structure according to the first embodiment can also be used as a positive electrode active material-containing layer, in that case, the counter electrode in this embodiment is a negative electrode.

The positive electrode may include a current collector (positive electrode current collector) and a positive electrode active material-containing layer provided on at least one main surface of the current collector. The positive electrode active material-containing layer contains a positive electrode active material and, if necessary, a conductive agent and a binder.

The positive electrode current collector contains, for example, a metal such as stainless steel, aluminum (Al), and titanium (Ti). The positive electrode current collector has, for example, a foil shape, a porous body shape, or a mesh shape. In order to prevent corrosion due to a reaction between the positive electrode current collector and the aqueous electrolyte, a surface of the positive electrode current collector may be coated with a different element. The positive electrode current collector is preferably, for example, a Ti foil having excellent corrosion resistance and oxidation resistance. Note that, in a case where Li₂SO₄ is used as the aqueous electrolyte, Al may be used as the positive electrode current collector because corrosion does not proceed.

The positive electrode active material-containing layer contains a positive electrode active material. The positive electrode active material-containing layer may be supported on both front and rear main surfaces of the positive electrode current collector.

As the positive electrode active material, a compound in which a lithium ion insertion/extraction potential is 2.5 V (vs. Li/Lit) to 5.5 V (vs. Li/Li⁺) with respect to an oxidation/reduction potential of lithium can be used. The positive electrode may contain one kind of compound alone as the positive electrode active material, or may contain two or more compounds as the positive electrode active material.

Examples of the compound that can be used as the positive electrode active material include a lithium-manganese composite oxide, a lithium-nickel composite oxide, a lithium-cobalt-aluminum composite oxide, a lithium-nickel-cobalt-manganese composite oxide, a spinel-type lithium-manganese-nickel composite oxide, a lithium-manganese-cobalt composite oxide, a lithium-iron oxide, lithium fluorinated iron sulfate, and a phosphate compound having an olivine crystal structure (For example, a compound that is expressed by Li_{z}FePO₄ and satisfies a relationship of 0<z≤1, and a compound that is expressed by Li_{z}MnPO₄ and satisfies a relationship of 0<z≤1). The phosphate compound having an olivine crystal structure is excellent in thermal stability.

Examples of a compound capable of obtaining a high positive electrode potential include a lithium-manganese composite oxide such as a compound that is expressed by Li_{z}Mn₂O₄ having a spinel structure and satisfies a relationship of 0<z≤1, and a compound that is expressed by Li_{z}MnO₂ and satisfies a relationship of 0<z≤1; a lithium-nickel-aluminum composite oxide such as a compound that is expressed by Li_{z}Ni₁₋ⱼAlⱼO₂ and satisfies relationships of 0<z≤1 and 0<j<1; a lithium-cobalt composite oxide such as a compound that is expressed by Li_{z}CoO₂ and satisfies a relationship of 0<z≤1; a lithium-nickel-cobalt composite oxide such as a compound that is expressed by Li_{z}Ni₁₋ⱼ₋ₖCOⱼMnKO₂ and satisfies relationships of 0<z≤1, 0<j<1, and 0≤k<1; a lithium-manganese-cobalt composite oxide such as a compound that is expressed by Li_{z}MnⱼCo₁₋ⱼO₂ and satisfies relationships of 0<z≤1 and 0<j<1; a spinel-type lithium-manganese-nickel composite oxide such as a compound that is expressed by Li_{z}Mn₂₋ᵢNiⱼO₄ and satisfies relationships of 0<z≤1 and 0<i<2; a lithium phosphorus oxide having an olivine structure such as a compound that is expressed by Li_{z}FePO₄ and satisfies a relationship of 0<z≤1, a compound that is expressed by Li_{z}Fe_{1-y}Mn_{y}PO₄ and satisfies relationships of 0<z≤1 and 0≤y≤1, and a compound that is expressed by Li_{z}CoPO₄ and satisfies a relationship of 0<z≤1; and fluorinated iron sulfate (for example, a compound that is expressed by Li_{z}FeSO₄F and satisfies a relationship of 0<z≤1).

The positive electrode active material preferably contains one or more selected from the group consisting of the lithium-cobalt composite oxide, the lithium-manganese composite oxide, and the lithium phosphorus oxide having an olivine structure. An operation potential of these compounds is 3.5 V (vs. Li/Li⁺) to 4.2 V (vs. Li/Li⁺). That is, the operation potentials of these compounds as active materials are relatively high. When using these compounds in combination with the above-described negative electrode active materials such as spinel-type lithium titanate and anatase-type titanium oxide, a high battery voltage can be obtained.

The positive electrode active material is contained in the positive electrode, for example, in a form of particles. The positive electrode active material particles may be single primary particles, secondary particles that are aggregates of the primary particles, or a mixture of a primary particle and a secondary particle. The shape of the particles is not particularly limited, and can be, for example, a spherical shape, an elliptical shape, a flat shape, or a fibrous shape.

The average particle size (diameter) of the primary particles of the positive electrode active material is preferably 10 μm or less, and more preferably 0.1 μm to 5 μm. The secondary particles of the positive electrode active material preferably have an average particle size (diameter) of 100 μm or less, and more preferably 10 μm to 50 μm. The primary particle size and the secondary particle size of the positive electrode active material can be measured in a similar manner as in the negative electrode active material particles.

The conductive agent is blended as necessary in order to enhance a current collection performance and suppress contact resistance between the positive electrode active material and the current collector. Examples of the conductive agent include carbonaceous materials such as acetylene black, Ketjen black, graphite, and coke. The conductive agent may be used alone or in combination of two or more kinds thereof.

The binder has an operation of binding the positive electrode active material and the conductive agent. As the binder, for example, at least one selected from the group consisting of PTFE, PVdF, fluororubber, ethylene-butadiene rubber, polypropylene (PP), polyethylene (PE), CMC, polyimide (PI), and polyacrylimide (PAI) can be used, but the binder is not limited thereto. For example, a polymer material included in the separator layer can be used as the binder. When using the same material as the polymer material used for the separator layer as the binder used for the positive electrode active material-containing layer, the degree of binding between both the layers, that is, peel strength can be improved. The binding agent may be used alone or in combination of two or more kinds thereof.

Blending ratios of the positive electrode active material, the conductive agent, and the binder in the positive electrode active material-containing layer are preferably 70 mass % to 95 mass %, 3 mass % to 20 mass %, and 2 mass % to 10 mass %, respectively. When the blending ratio of the conductive agent is 3 mass % or more, the conductivity of the positive electrode can be improved, and when the blending ratio is 20 mass % or less, decomposition of the aqueous electrolyte on the surface of the conductive agent can be reduced. When the blending ratio of the binder is 2 mass % or more, sufficient electrode strength is obtained, and when the blending ratio is 10 mass % or less, the insulating portion of the electrode can be reduced.

### (Exterior Member)

As an exterior member in which the electrode group and the aqueous electrolyte are accommodated, a metal container, a laminate film container, or a resin container can be used.

As the metal container, a metal can that is made of nickel, iron, stainless steel, or the like and has a square shape or cylindrical shape can be used. As the resin container, a container made of polyethylene, polypropylene, or the like can be used.

A plate thickness of each of the resin container and the metal container is preferably in a range of 0.05 mm to 1 mm. The plate thickness is more preferably 0.5 mm or less, and still more preferably 0.3 mm or less.

Examples of the laminate film include a multilayer film in which a metal layer is coated with a resin layer. Examples of the metal layer include stainless steel foil, aluminum foil, and aluminum alloy foil. For the resin layer, polymers such as PP, PE, nylon, and polyethylene terephthalate (PET) can be used. The thickness of the laminate film is preferably in a range of 0.01 mm to 0.5 mm. The thickness of the laminate film is more preferably 0.2 mm or less.

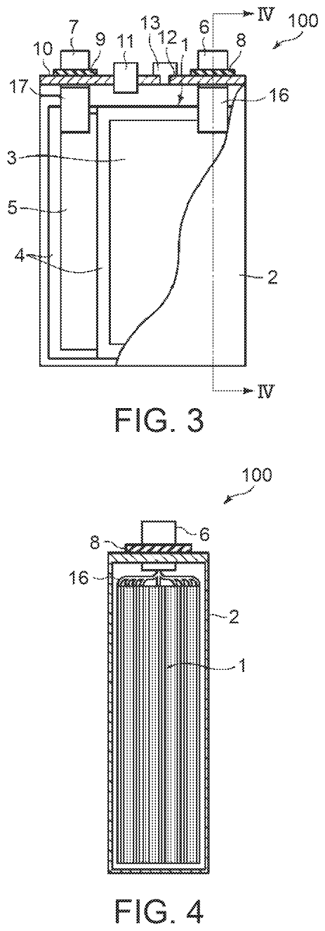

FIG. 3 is a cross-sectional view schematically illustrating an example of the secondary battery according to an embodiment. FIG. 4 is a cross-sectional view taken along line IV-IV of the secondary battery illustrated in FIG. 3.

The electrode group 1 is accommodated in an exterior member 2 that is a rectangular cylindrical metal container. The electrode group 1 includes an electrode structure (negative electrode structure) including a negative electrode 3 and a composite film 4, and a positive electrode 5 that is a counter electrode of the negative electrode 3. The electrode group 1 has a structure in which the electrode structure and the positive electrode 5 are disposed so that the composite layer 4 as a separator is interposed between the positive electrode 5 and the negative electrode 3, and the positive electrode 5 and the negative electrode 3 are spirally wound so as to have a flat shape. An aqueous electrolyte (not illustrated) is held by the electrode group 1. As shown in FIG. 3, a strip-shaped negative electrode lead 16 is electrically connected to each of a plurality of sites of an end of the negative electrode 3 located on an end surface of the electrode group 1. In addition, a strip-shaped positive electrode lead 17 is electrically connected to each of a plurality of sites of an end of the positive electrode 5 located on the end surface. A plurality of the negative electrode leads 16 are connected to a negative electrode terminal 6 in a bundled state as illustrated in FIG. 4. In addition, although not illustrated, the positive electrode lead 17 is also electrically connected to a positive electrode terminal 7 in a bundled state in a similar manner.

A metal sealing plate 10 is fixed to an opening of the metal exterior member 2 by welding or the like. The negative electrode terminal 6 and the positive electrode terminal 7 are drawn out to the outside from extraction holes provided in the sealing plate 10. A negative electrode gasket 8 and a positive electrode gasket 9 are respectively disposed on inner peripheral surfaces of the extraction holes in the sealing plate 10 in order to avoid a short-circuit due to contact with the negative electrode terminal 6 and the positive electrode terminal 7. When disposing the negative electrode gasket 8 and the positive electrode gasket 9, airtightness of a secondary battery 100 can be maintained.

The sealing plate 10 is provided with a control valve 11 (safety valve). When the internal pressure in the battery cell increases due to a gas generated by the electrolysis of water, the generated gas can be released from the control valve 11 to the outside. As the control valve 11, for example, a return-type valve that operates when the internal pressure becomes higher than a set value and functions as a sealing plug when the internal pressure decreases can be used. Alternatively, a non-return type control valve in which the function as the sealing plug is not restored when operating once may be used. In FIG. 3, the control valve 11 is disposed at the center of the sealing plate 10, but the position of the control valve 11 may be set to an end of the sealing plate 10. The control valve 11 may be omitted.

The sealing plate 10 is provided with a liquid injection port 12. The aqueous electrolyte can be injected through the liquid injection port 12. The liquid injection port 12 can be closed by a sealing plug 13 after the aqueous electrolyte is injected. The liquid injection port 12 and the sealing plug 13 may be omitted.

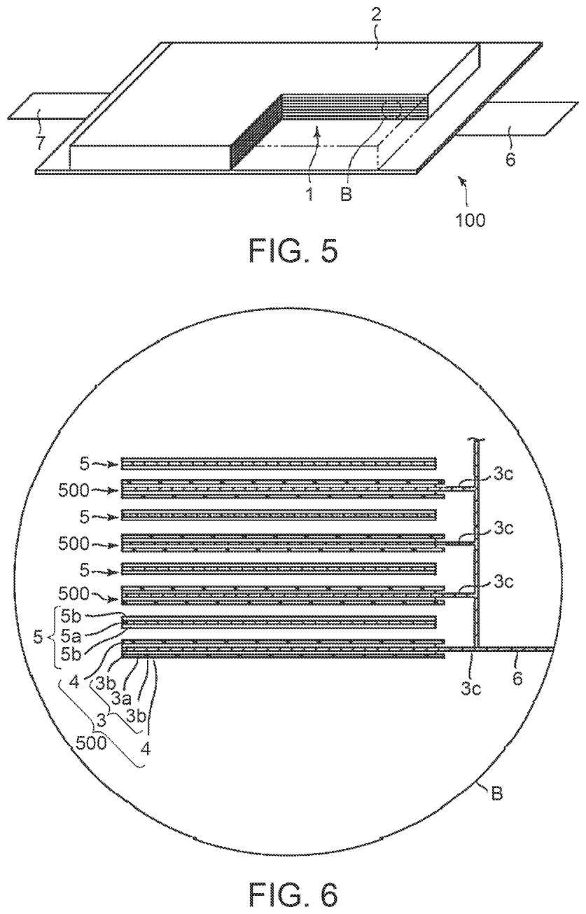

FIG. 5 is a partially cutaway perspective view schematically illustrating another example of the secondary battery according to the embodiment. FIG. 6 is an enlarged cross-sectional view of a part B of the secondary battery illustrated in FIG. 5. FIGS. 5 and 6 illustrate an example of a secondary battery 100 using a laminate film exterior member as the exterior member.

The secondary battery 100 illustrated in FIGS. 5 and 6 includes an electrode group 1 shown in FIGS. 5 and 6, an exterior member 2 illustrated in FIG. 5, and an aqueous electrolyte (not illustrated). The electrode group 1 and the aqueous electrolyte are accommodated in the exterior member 2. The aqueous electrolyte is held in the electrode group 1.

The exterior member 2 is made of a laminate film including two resin layers and a metal layer interposed therebetween.

As illustrated in FIG. 6, the electrode group 1 is a laminated electrode group. The laminated electrode group 1 has a structure in which an electrode structure 500 and a positive electrode 5 are alternately laminated.

The electrode group 1 includes a plurality of the electrode structures 500. Each of the electrode structures 500 includes a negative electrode 3, and composite films 4 supported on both surfaces of the negative electrode 3. Each negative electrode 3 includes a negative electrode current collector 3a and a negative electrode active material-containing layer 3b supported on both surfaces of the negative electrode current collector 3a. Each of composite films 4 is supported on the negative electrode active material-containing layer 3b of the negative electrode 3. In addition, the electrode group 1 includes a plurality of the positive electrodes 5. Each of the plurality of positive electrodes 5 includes a positive electrode current collector 5a and a positive electrode active material-containing layer 5b supported on both surfaces of the positive electrode current collector 5a.

The negative electrode current collector 3a of the negative electrode 3 includes a portion where the negative electrode active material-containing layer 3b is not provided on any surface thereof on one side. This portion serves as a negative electrode current collecting tab 3c. As illustrated in FIG. 6, the negative electrode current collecting tab 3c does not overlap the positive electrode 5. A plurality of the negative electrode current collecting tabs 3c are electrically connected to the strip-shaped negative electrode terminal 6. A tip end of the strip-shaped negative electrode terminal 6 is drawn to the outside of the exterior member 2.

Although not illustrated, the positive electrode current collector 5a of each of the positive electrodes 5 includes a portion where the positive electrode active material-containing layer 5b is not supported on any surface thereof on one side. This portion serves as a positive electrode collector tab. In a similar manner as in the negative electrode current collecting tab 3c, the positive electrode current collecting tab does not overlap the 3. The positive electrode current negative electrode collecting tab is located on the opposite side of the electrode group 1 with respect to the negative electrode current collecting tab 3c. The positive electrode tab is electrically connected to the strip-shaped positive electrode terminal 7. The tip end of the strip-shaped positive electrode terminal 7 is located on a side opposite to the negative electrode terminal 6 and is drawn to the outside of the exterior member 2.

The secondary battery according to the second embodiment includes the electrode structure according to the first embodiment and a counter electrode. According to this, the secondary battery can suppress an increase in resistance while suppressing electrolysis of water accompanying a side reaction.

### Third Embodiment

According to a third embodiment, an assembled battery is provided. The assembled battery includes a plurality of the secondary batteries according to the second embodiment.

In the assembled battery according to the embodiment, the unit cells may be arranged to be electrically connected in series or in parallel, or may be arranged in combination of series connection and parallel connection.

Next, an example of the assembled battery will be described with reference to the drawings.

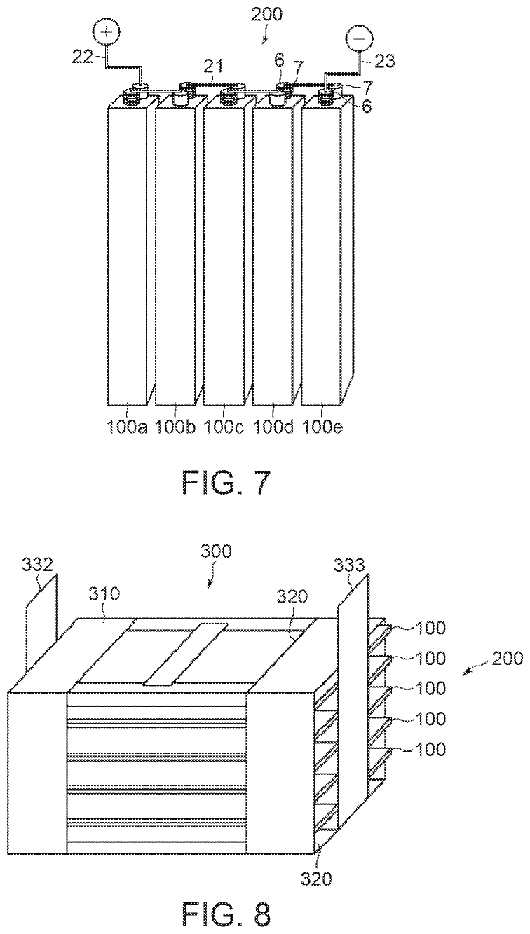

FIG. 7 is a perspective view schematically illustrating an example of an assembled battery according to an embodiment. An assembled battery 200 illustrated in FIG. 7 includes five unit cells 100a to 100e, four bus bars 21, a positive electrode side lead 22, and a negative electrode side lead 23. Each of the five unit cells 100a to 100e is the secondary battery according to the third embodiment.

For example, the bus bar 21 connects the negative electrode terminal 6 of one unit cell 100a and the positive electrode terminal 7 of the adjacent unit cell 100b. In this way, the five unit cells 100 are connected in series by the four bus bars 21. That is, the assembled battery 200 in FIG. 7 is an assembled battery of five series. Although an example is not illustrated, in an assembled battery including a plurality of unit cells electrically connected in parallel, for example, the plurality of unit cells can be electrically connected by connecting a plurality of negative electrode terminals to each other by a bus bar and connecting a plurality of positive electrode terminals to each other by a bus bar.

The positive electrode terminal 7 of at least one of the five unit cells 100a to 100e is electrically connected to the positive electrode side lead 22 for external connection. The negative electrode terminal 6 of at least one of the five unit cells 100a to 100e is electrically connected to the negative electrode side lead 23 for external connection.

As described above, the assembled battery according to this embodiment includes the secondary battery according to the second embodiment. Accordingly, the assembled battery can suppress an increase in resistance while suppressing electrolysis of water accompanying a side reaction.

### Fourth Embodiment

According to a fourth embodiment, a battery pack including the secondary battery according to the second embodiment is provided. The battery pack can include the assembled battery according to the third embodiment. The battery pack may include the single secondary battery according to the second embodiment instead of the assembled battery according to the third embodiment.

The battery pack may further include a protection circuit. The protection circuit has a function of controlling charge and discharge of the secondary battery. Alternatively, a circuit included in a device (for example, an electronic device, an automobile, or the like) using the battery pack as a power supply may be used as the protection circuit of the battery pack.

The battery pack may further include an external power distribution terminal. The external power distribution terminal is configured to output a current from the secondary battery to the outside and/or to input a current from the outside to the secondary battery. In other words, when the battery pack is used as a power supply, a current is supplied to the outside through the external power distribution terminal. When the battery pack is charged, a charging current (including regenerative energy of power of an automobile or the like) is supplied to the battery pack through the external power distribution terminal.

Next, an example of the battery pack according to an embodiment will be described with reference to the drawings.

FIG. 8 is a perspective view schematically illustrating an example of a battery pack according to an embodiment.

For example, a battery pack 300 includes an assembled battery including the secondary battery illustrated in FIGS. 5 and 6. The battery pack 300 includes a housing 310 and the assembled battery 200 accommodated in the housing 310. In the assembled battery 200, a plurality of (for example, five) the secondary batteries 100 are electrically connected in series. The secondary batteries 100 are laminated in a thickness direction. The housing 310 has an opening 320 in an upper portion and four side surfaces. The side surfaces of the secondary battery 100 from which the negative electrode terminal 6 and the positive electrode terminal 7 protrude are exposed to the openings 320 of the housing 310. An output positive electrode terminal 332 of the assembled battery 200 has a strip shape, and in the output positive electrode terminal 332, one end is electrically connected to the positive electrode terminal 7 of any one of the secondary batteries 100, and the other end protrudes from the opening 320 of the housing 310 and protrudes from an upper portion of the housing 310. On the other hand, an output negative electrode terminal 333 of the assembled battery 200 has a strip shape, and in the output negative electrode terminal 333, one end is electrically connected to the negative electrode terminal 6 of any one of the secondary batteries 100, and the other end protrudes from the opening 320 of the housing 310 and protrudes from an upper portion of the housing 310.

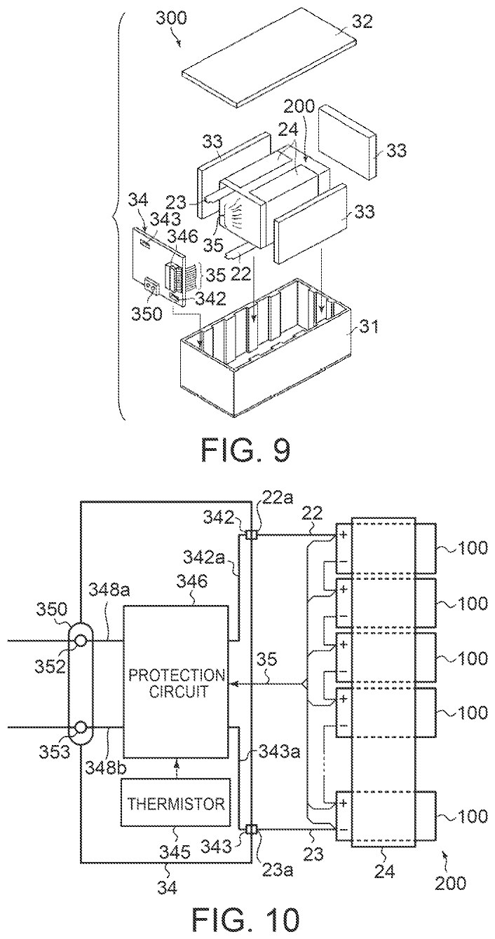

Another example of the battery pack will be described in detail with reference to FIGS. 9 and 10. FIG. 9 is an exploded perspective view schematically illustrating another example of the battery pack according to the embodiment. FIG. 10 is a block diagram illustrating an example of an electric circuit of the battery pack illustrated in FIG. 9.

A battery pack 300 illustrated in FIGS. 9 and 10 includes an accommodation container 31, a lid 32, a protective sheet 33, the assembled battery 200, a printed wiring board 34, a wiring 35, and an insulating plate (not illustrated).

The accommodation container 31 illustrated in FIG. 9 is a bottomed square container having a rectangular bottom surface. The accommodation container 31 is configured to accommodate the protective sheet 33, the assembled battery 200, the printed wiring board 34, and the wiring 35. The lid 32 has a rectangular shape. The lid 32 covers the accommodation container 31 to accommodate the assembled battery 200 and the like. Although not illustrated, the accommodation container 31 and the lid 32 are provided with an opening, a connection terminal, or the like for connection to an external device or the like.

The assembled battery 200 includes a plurality of the unit cells 100, the positive electrode side lead 22, the negative electrode side lead 23, and an adhesive tape 24.

At least one of the plurality of unit cells 100 is the secondary battery according to the embodiment. The plurality of unit cells 100 are electrically connected in series as illustrated in FIG. 10. The plurality of unit cells 100 may be electrically connected in parallel, or may be connected in a combination of series connection and parallel connection. When the plurality of unit cells 100 are connected in parallel, the battery capacity increases as compared with a case where the unit cells 100 are connected in series.

The adhesive tape 24 fastens the plurality of unit cells 100. Instead of the adhesive tape 24, a heat-shrinkable tape may be used to fix the unit cells 100. In this case, the protective sheet 33 is disposed on both side surfaces of the assembled battery 200, the heat-shrinkable tape is wound around, and then the heat-shrinkable tape is heat-shrunk to bind the plurality of unit cells 100.

One end of the positive electrode side lead 22 is connected to the assembled battery 200. One end of the positive electrode side lead 22 is electrically connected to the positive electrode of one or more unit cells 100. One end of the negative electrode side lead 23 is connected to the assembled battery 200. One end of the negative electrode side lead 23 is electrically connected to the negative electrode of one or more unit cells 100.

The printed wiring board 34 is installed along one of inner surfaces of the accommodation container 31 in a short-side direction. The printed wiring board 34 includes a positive electrode side connector 342, a negative electrode side connector 343, a thermistor 345, a protection circuit 346, wirings 342a and 343a, an external power distribution terminal 350, a positive side wiring 348a, and a negative side wiring 348b. One main surface of the printed wiring board 34 faces one side surface of the assembled battery 200. An insulating plate (not illustrated) is interposed between the printed wiring board 34 and the assembled battery 200.

The other end 22a of the positive electrode side lead 22 is electrically connected to the positive electrode side connector 342. The other end 23a of the negative electrode side lead 23 is electrically connected to the negative electrode side connector 343.

The thermistor 345 is fixed to the one main surface of the printed wiring board 34. The thermistor 345 detects a temperature of each of the unit cells 100 and transmits a detection signal thereof to the protection circuit 346.

The external power distribution terminal 350 is fixed to the other main surface of the printed wiring board 34. The external power distribution terminal 350 is electrically connected to a device existing outside the battery pack 300. The external power distribution terminal 350 includes a positive side terminal 352 and a negative side terminal 353.

The protection circuit 346 is fixed to the other main surface of the printed wiring board 34. The protection circuit 346 is connected to the positive side terminal 352 through the positive side wiring 348a. The protection circuit 346 is connected to the negative side terminal 353 through the negative side wiring 348b. In addition, the protection circuit 346 is electrically connected to the positive electrode side connector 342 through the wiring 342a. The protection circuit 346 is electrically connected to the negative electrode side connector 343 through the wiring 343a. Further, the protection circuit 346 is electrically connected to each of the plurality of unit cells 100 through the wiring 35.

The protective sheet 33 is disposed on both inner surfaces of the accommodation container 31 in a long side direction and an inner surface in a short-side direction facing the printed wiring board 34 through the assembled battery 200. The protective sheet 33 consists of, for example, a resin or a rubber.

The protection circuit 346 controls charge and discharge of the plurality of unit cells 100. In addition, the protection circuit 346 interrupts the electrical connection between the protection circuit 346 and the external power distribution terminal 350 (positive side terminal 352, negative side terminal 353) to the external device on the basis of the detection signal transmitted from the thermistor 345 or the detection signal transmitted from each of the unit cells 100 or the assembled battery 200.

Examples of the detection signal transmitted from the thermistor 345 include a signal obtained by detecting that the temperature of the unit cell 100 is equal to or higher than a predetermined temperature. Examples of the detection signal transmitted from each of the unit cells 100 or the assembled battery 200 include signals obtained by detecting overcharge, overdischarge, and overcurrent of the unit cell 100. In a case where overcharge or the like is detected for each of the unit cells 100, a battery voltage may be detected, or a positive electrode potential or a negative electrode potential may be detected. In the latter case, a lithium electrode used as a reference electrode is inserted into the unit cell 100.

As the protection circuit 346, a circuit included in a device (for example, an electronic device, an automobile, or the like) using the battery pack 300 as a power supply may be used.

As described above, the battery pack 300 includes the external power distribution terminal 350. Accordingly, the battery pack 300 can output a current from the assembled battery 200 to the external device and can input a current from the external device to the assembled battery 200 through the external power distribution terminal 350. In other words, when the battery pack 300 is used as a power supply, a current from the assembled battery 200 is supplied to the external device through the external power distribution terminal 350. When the battery pack 300 is charged, a charging current from the external device is supplied to the battery pack 300 through the external power distribution terminal 350. When the battery pack 300 is used as an in-vehicle battery, regenerative energy of power of the vehicle can be used as a charge current from the external device.

The battery pack 300 may include a plurality of the assembled batteries 200. In this case, the plurality of assembled batteries 200 may be connected in series, connected in parallel, or connected in a combination of series connection and parallel connection. In addition, the printed wiring board 34 and the wiring 35 may be omitted. In this case, the positive electrode side lead 22 and the negative electrode side lead 23 may be used as a positive side terminal and a negative side terminal of the external power distribution terminal, respectively.

The battery pack is used, for example, for applications requiring excellent cycle performance when a large current is taken out. Specifically, the battery pack is used as, for example, a power supply of an electronic device, a stationary battery, and an in-vehicle battery of various vehicles. Examples of the electronic device include a digital camera. The battery pack is particularly suitably used as an in-vehicle battery.

The battery pack according to the fourth embodiment includes the secondary battery according to the second embodiment or the assembled battery according to the third embodiment. Therefore, the battery pack can suppress an increase in resistance while suppressing electrolysis of water accompanying a side reaction.

### Fifth Embodiment

According to a fifth embodiment, a vehicle including the battery pack according to the fourth embodiment is provided.

In such a vehicle, the battery pack recovers, for example, regenerative energy of power of the vehicle. The vehicle may include a mechanism (regenerator) that converts kinetic energy of the vehicle into regenerative energy.

Examples of the vehicle according to the embodiment include two-wheeled to four-wheel hybrid electric vehicles, two-wheeled to four-wheeled electric vehicles, an assist bicycle, and a railway vehicle.

The mounting position of the battery pack in the vehicle according to the embodiment is not particularly limited. For example, in a case where the battery pack is mounted on an automobile, the battery pack can be mounted in an engine room of the vehicle, behind the vehicle body, or under a seat.

In the vehicle according to the embodiment, a plurality of the battery packs may be mounted. In this case, batteries included in the respective battery packs may be electrically connected in series, electrically connected in parallel, or electrically connected in a combination of series connection and parallel connection. For example, in a case where each of the battery packs includes an assembled battery, a plurality of the assembled batteries may be electrically connected in series, electrically connected in parallel, or electrically connected in combination of series connection and parallel connection. Alternatively, in a case where each of the battery packs includes a single battery, a plurality of the batteries may be electrically connected in series, electrically connected in parallel, or electrically connected in combination of series connection and parallel connection.

Next, an example of a vehicle according to an embodiment will be described with reference to the drawings.

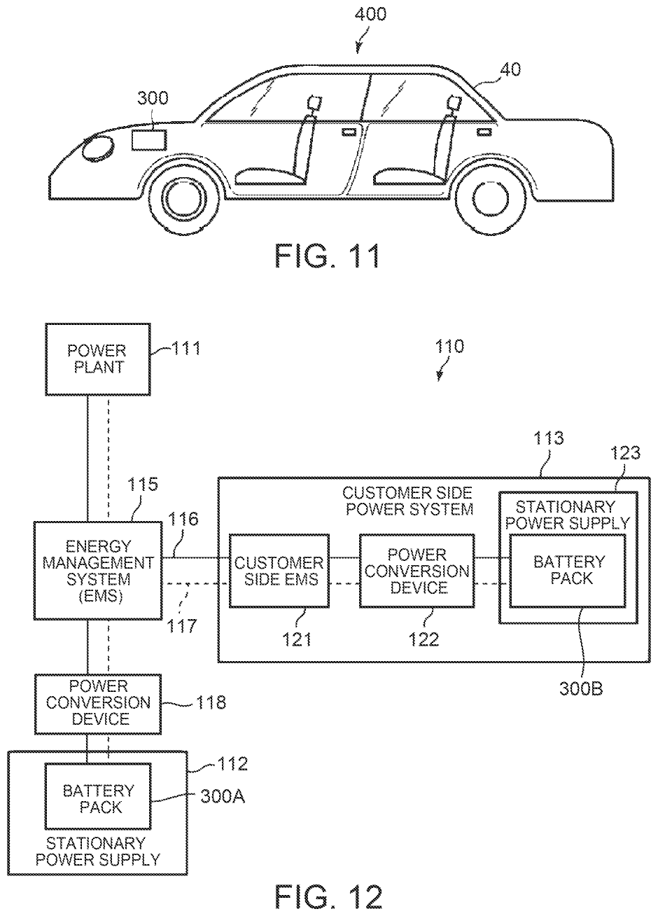

FIG. 11 is a partially transparent view schematically illustrating an example of the vehicle according to the embodiment.

A vehicle 400 illustrated in FIG. 11 includes a vehicle body 40 and the battery pack 300 according to the fifth embodiment. In the example illustrated in FIG. 11, the vehicle 400 is a four-wheeled automobile.

In the vehicle 400, a plurality of the battery packs 300 may be mounted. In this case, batteries (for example, a single battery or an assembled battery) included in the battery pack 300 may be connected in series, connected in parallel, or connected in a combination of series connection and parallel connection.

FIG. 11 illustrates an example in which the battery pack 300 is mounted in an engine room located in front of the vehicle body 40. As described above, the battery pack 300 may be mounted, for example, behind the vehicle body 40 or under a seat. The battery pack 300 can be used as a power supply of the vehicle 400. In addition, the battery pack 300 can recover regenerative energy of the power of the vehicle 400.

In the vehicle according to the fifth embodiment, the battery pack according to the fourth embodiment is mounted. Accordingly, the vehicle is excellent in traveling performance and reliability.

### Sixth Embodiment

According to a sixth embodiment, a stationary power supply including the battery pack according to the fourth embodiment is provided.

Instead of the battery pack according to the fifth embodiment, the assembled battery according to the fourth embodiment or the secondary battery according to the third embodiment may be mounted as the stationary power supply. The stationary power supply according to the embodiment can achieve a long operational lifespan.

FIG. 12 is a block diagram illustrating an example of a system including a stationary power supply according to an embodiment. FIG. 12 is a diagram illustrating an application example to stationary power supplies 112 and 123 as a use example of the battery packs 300A and 300B according to the embodiment. In the example illustrated in FIG. 12, a system 110 in which stationary power supplies 112 and 123 are used is illustrated. The system 110 includes a power plant 111, the stationary power supply 112, a customer side power system 113, and an energy management system (EMS) 115. In addition, a power network 116 and a communication network 117 are formed in the system 110, and the power plant 111, the stationary power supply 112, the customer side power system 113, and the EMS 115 are connected through the power network 116 and the communication network 117. The EMS 115 performs control to stabilize the entire system 110 by utilizing the power network 116 and the communication network 117.

The power plant 111 generates a large amount of electric power by a fuel source such as thermal power and nuclear power. Electric power is supplied from the power plant 111 through the power network 116 and the like. A battery pack 300 A is mounted on the stationary power supply 112. The battery pack 300 A can store electric power or the like supplied from the power plant 111. In addition, the stationary power supply 112 can supply the electric power stored in the battery pack 300 A through the electric power network 116 or the like. The system 110 is provided with a power conversion device 118. The power conversion device 118 includes a converter, an inverter, a transformer, and the like. Accordingly, the power conversion device 118 can perform conversion between direct current and alternating current, conversion between alternating currents having different frequencies from each other, transformation (step-up and step-down), and the like. Therefore, the power conversion device 118 can convert the electric power from the power plant 111 into electric power that can be stored in the battery pack 300A.

The customer side power system 113 includes a power system for a factory, a power system for a building, a power system for home use, and the like. The customer side power system 113 includes a customer side EMS 121, a power conversion device 122, and the stationary power supply 123. The battery pack 300B is mounted on the stationary power supply 123. The customer side EMS 121 performs control to stabilize the customer side power system 113.

The electric power from the power plant 111 and the electric power from the battery pack 300A are supplied to the customer side power system 113 through the power network 116. The battery pack 300B can store the electric power supplied to the customer side power system 113. Similarly to the power conversion device 118, the power conversion device 122 includes a converter, an inverter, a transformer, and the like. Accordingly, the power conversion device 122 can perform conversion between direct current and alternating current, conversion between alternating currents having different frequencies from each other, transformation (step-up and step-down), and the like. Therefore, the power conversion device 122 can convert the electric power supplied to the customer side power system 113 into electric power that can be stored in the battery pack 300B.

The electric power stored in the battery pack 300B can be used, for example, for charging a vehicle such as an electric vehicle. The system 110 may also be provided with a natural energy source. In this case, the natural energy source generates electric power by natural energy such as wind power and sunlight. Then, electric power is also supplied from the natural energy source in addition to the power plant 111 through the electric power network 116.

### EXAMPLES

### Example 1

### <Preparation of Electrode Structure>

In Example 1, an electrode structure used as a negative electrode was manufactured based on the following method. Proportions of a conductive agent and a binder in a negative electrode active material-containing layer were set to 5 parts by mass and 1 part by mass, respectively, with respect to 100 parts by mass of negative electrode active material. A lithium-titanium oxide Li₄Ti₅O₁₂ (TLO) powder in which an average particle size of primary particles was 1 μm as the negative electrode active material, a graphite powder as the conductive agent, and PVdF as the binder were mixed and dispersed in an N-methyl-2 pyrrolidone (NMP) solvent to prepare slurry for forming an active material-containing layer.

The slurry for preparing the negative electrode was applied to both surfaces of 12 μm thick Al foil used as a negative electrode current collector and was dried. At this time, a drying temperature of the negative electrode active material-containing slurry was 130° C., and a slurry coating speed was 1 m/min. The laminate was pressed at 5 kN to obtain the negative electrode.

Next, two types of slurry for forming a composite layer were prepared in the following procedure. First, with regard to Slurry 1 for forming a composite layer, an Al₂O₃ powder having a mode diameter of 0.8 μm was prepared as inorganic solid particles and PVdF was prepared as a polymer material. The inorganic solid particles and the polymer material were mixed at a mass ratio of 9:1, were suspended in NMP as a solvent, and were mixed for 30 minutes by using a mixer. Similarly, with regard to Slurry 2 for forming a composite layer, a bimodal Al₂O₃ powder containing particles having a mode diameter of 0.8 μm and a mode diameter of 5 μm at a mass ratio of 2:1 was used as inorganic solid particles, was mixed with a polymer material in a similar manner as Slurry 1, and the resultant mixture was suspended in a solvent and was mixed for 30 minutes by using a mixer. With respect to Slurry 1 and Slurry 2 for forming a composite layer which were obtained, aggregated secondary particles were crushed by using a bead mill. Particle size distribution measurement was performed by using a laser diffraction method on Slurry 1 and Slurry 2 for forming a composite layer which were obtained, and as a result thereof, it was found that particle size distributions of Slurry 1 and Slurry 2 for forming a composite layer had respective modal and bimodal characteristics. Slurry 1 for forming a composite layer was applied to a surface layer of the negative electrode obtained previously by a micro-gravure coating method in an application thickness of 8 μm, and was dried at a temperature of 130° C. Next, Slurry 2 for forming a composite layer was recoated by the micro-gravure coating method in a coating thickness of 12 μm, and was dried at a temperature of 130° C., on the surface layer of the negative electrode coated with Slurry 1 for forming a composite layer which was obtained previously. The laminate was pressed at 5 kN to obtain an electrode structure.

<Preparation of Counter Electrode>90 mass % of LiNi_{0.5}Co_{0.2}Mn_{0.3}O₂ composite oxide having a mode diameter of primary particles of 2 μm as a positive electrode active material, 5 mass % of graphite powder as a conductive agent, and 5 mass % of PVdF as a binder were blended and dispersed in an NMP solvent to prepare slurry for forming an active material-containing layer.

A positive electrode active material, a conductive agent, a binder, and a solvent were mixed to prepare slurry for preparing a positive electrode. As the positive electrode active material, 90 mass % of LiNi_{0.5}Co_{0.2}Mn_{0.3}O₂ composite oxide having a mode diameter of primary particles of 2 μm was used. As the conductive agent, 5% by mass of graphite powder was used. As the binder, 5 mass % of PVdF was blended and dispersed in an NMP solvent. The mass ratio of the positive electrode active material, the conductive agent, and the binder in the slurry was set to 90:5:5. The slurry for preparing a positive electrode was applied to both surfaces of 12 μm Ti foil used as a positive electrode current collector and was dried. At this time, a drying temperature of the positive electrode active material-containing slurry was 130° C., and a slurry coating speed was 1 m/min. The laminate was pressed at 5 kN to obtain a positive electrode.

### <Preparation of Electrode Group>

The electrode structure supporting the composite layer, and the positive electrode, were laminated to obtain a laminate. The laminate was spirally wound so that the negative electrode side was located at the outermost periphery, and then pressed at 5 kN to prepare a flat electrode group.

### <Assembly of Battery>

The obtained electrode group was accommodated in a polypropylene resin container. Next, an aqueous solution containing 12 M lithium chloride prepared as an aqueous electrolyte was injected into the container to prepare a secondary battery.

### <Constant Current Charge and Discharge Test and Measurement of 2C Capacity Retention Rate>

For each of the batteries prepared in Examples 1 to 12 and Comparative Examples 1 to 7, a test battery was prepared, and then the following capacity evaluation was performed. The battery was charged and discharged for 1 cycle at a rate of 0.2C, and then charged under conditions of 0.2C, CC-CV, and the current termination condition was set to 0.1C. Next, 0.2C-CC discharge was performed up to a specified voltage of 1.5 V. The charge capacity and 0.2C discharge capacity of the battery were acquired. The obtained 0.2C discharge capacity was divided by the charge capacity of the battery to calculate the 0.2C coulombic efficiency. Next, the battery was charged and discharged for 1 cycle at a rate of 0.2C, and then charged under conditions of 0.2C, CC-CV, and the current termination condition was set to 0.1C. Next, 2C discharge capacity was acquired by performing 2C-CC discharge up to a specified voltage of 1.5 V. The obtained 2C discharge capacity was divided by 0.2C discharge capacity to obtain a 2C capacity retention rate.

### <Measurement Relating to Thickness Ratio of First Region and Second Region>

### (Pretreatment of Secondary Battery)

First, after the secondary battery was brought into a discharged state, the secondary battery was disassembled to collect the electrode group including the composite layer. The disassembly was performed in the atmosphere. Subsequently, the taken-out electrode group was immersed in pure water for 3 minutes, and then dried at 100° C. for 5 minutes.

### (Cutting of Electrode Group)

Next, the electrode group was subjected to focused ion beam FIB processing, and the cut cross-section was observed with an SEM. Here, SMI3300SE manufactured by Hitachi, and Strata 400s manufactured by FEI were used as the FIB apparatus. As the cutting of the electrode group, cutting was performed at a position equally dividing a main surface of the electrode group into six in a short side direction when viewed from an upper side to obtain five cross sections.

### (Observation of Cross-Section of Electrode Structure)

After obtaining the cross-sections of the electrode group by the FIB processing, each of the cross-sections of the electrode structure including the electrode and the composite layer was observed with an SEM. As the SEM apparatus, U8020 manufactured by Hitachi High-Technologies Corporation was used. As an observation site of the SEM, a region where the electrode and the composite layer existed was selected. As measurement conditions, a measurement magnification was set to 5000 times and an SEM image displayed with the number of pixels of 960×960×960 was converted into monochrome 256 gradations. A thickness direction of the layer was divided into 2:8, and a side in contact with the negative electrode was set as a first region, and the other side was set as a second region.

### (Binarization of SEM Image)

The obtained SEM image was binarized by ImageJ in which a median value between luminosity of inorganic particles and luminosity of a resin in the composite layer was set as a threshold value.

### (Calculation of Thickness Ratio of First Region and Second Region)

With respect to the binarized SEM image, after spherical or roughly spherical particles having high luminosity were detected in the composite layer, a one-particle average particle size Rp [μm] which is an arithmetic average value of a maximum value and a minimum value of a size in each particle was obtained. An average particle size of each particle was calculated by obtaining each Rp of all particles included in the first region by arithmetically averaging. Particles having an average particle size Rp of 3 μm or more were detected in the composite layer, and a cumulative frequency distribution of inorganic particles having an average particle size Rp of 3 μm or more in the composite layer was drawn with respect to a thickness direction from an interface between the electrode and the composite layer to a surface of the composite layer facing the interface. At that time, the number of all inorganic particles having an average particle size Rp of 3 μm or more was normalized to 100. At this time, with respect to an axial direction of the thickness of the composite layer, a range where the cumulative frequency of the inorganic particles was 0 or more and less than 25 was defined as the first region, and a range where the cumulative frequency was 25 or more and 100 or less was defined as the second region. The ratio of the thickness of the first region or the thickness of the second region to the thickness of the composite layer was hereinafter referred to as a thickness ratio [%] of the first region or a thickness ratio [%] of the second region.

The operations from (observation of the cross-section of the electrode structure) to (calculation of the thickness ratio of the first region and the second region) described above are performed on each cross-section, and the ratio of the thickness of the first region to the thickness of the composite layer obtained in the cross-section was arithmetically averaged. In the following measurement, the arithmetically averaged value was used for the range of the first region.

### <Measurement of Average Particle Size of Inorganic Particles of Composite Layer>

First, the thickness ratio of the first region, which is a fixed ratio calculated in <Measurement Relating to Thickness Ratio of First Region and Second Region> described above, was applied to each cross-section imaged by the SEM. That is, the thickness 61t of the first region 61 and the thickness 62t of the second region 62 calculated in <Measurement Relating to Thickness Ratio of First Region and Second Region> were fixed, and the average particle size of the inorganic particles in each of the fixed regions was calculated.

Next, with respect to the first region of the SEM image binarized by the method described above in (Binarization of SEM Image), spherical or roughly spherical particles having high luminosity were detected, and the average particle size Rp [μm] of one particle, which is the arithmetic average value of the maximum value and the minimum value of the size in one particle, was obtained. The calculation of Rp was performed for all of the particles included in the first region. The obtained Rp of each of the all particles was arithmetically averaged to calculate an average particle size R1-1 of the inorganic particles in the first region in one SEM image. The average particle size R1 of the inorganic particles in the first region was obtained by arithmetically averaging the above-described R1-1 calculated for each SEM image. Calculation for the second region was also performed in a similar manner as in the first region to obtain the average particle size R2.

### <Measurement of Number N1 and N2 of Inorganic Particles>

First, the thickness ratio of the first region, which is a fixed ratio calculated in <Measurement Relating to Thickness Ratio of First Region and Second Region> described above, was applied to each cross-section imaged by the SEM. That is, the thickness 61t of the first region 61 and the thickness 62t of the second region 62 calculated in <Measurement Relating to Thickness Ratio of First Region and Second Region> were fixed, and the number of the inorganic particles in each of the fixed regions was calculated.

On the basis of <Measurement of Average Particle Size of Inorganic Particles of Composite Layer>, the number of particles in which Rp is 0.2 μm or more and 3 μm or less was separately calculated in the first region and the second region from Rp of each of all particles detected in the composite layer. The number of particles in the first region was denoted by N1-1, and the number of particles in the second region was denoted by N2-1. The number N1 and the number N2 to be obtained were calculated by arithmetically averaging the number N1-1 and the number N2-1 calculated in each SEM image.

### <Measurement of Pore Sizes P1 and P2 Included in First Region and Second Region>

First, the thickness ratio of the first region 61, which is a fixed ratio calculated in <Measurement Relating to Thickness Ratio of First Region and Second Region> described above, was applied to each cross-section. That is, the thickness 61t of the first region 61 and the thickness 62t of the second region 62 calculated in <Measurement Relating to Thickness Ratio of First Region and Second Region> were fixed, and the pore size in each of the fixed regions was calculated.

The SEM image described in (Observation of Cross-Section of Electrode Structure) of <Measurement Relating to Thickness Ratio of First Region and Second Region> was used. With respect to the SEM image, the solid particles and the binder were displayed to be white and voids were displayed to be black by a binarization treatment in which luminosity of a median value between luminosity of the resin and luminosity of the interface between the composite layer and the active material-containing layer was set as a threshold value. After extracting the black void portion with respect to the first region 61 of the obtained image, a pore size in the void portion was calculated by a sphere arrangement method. That is, a plurality of virtual spheres were applied to the void portion under a constraint condition that diameters of respective spheres became maximum, and a value obtained by arithmetically averaging the diameters of the spheres was set as a pore size P₁₋₁. The pore size P₁₋₁ is calculated in each SEM image, and an arithmetic average thereof was set as the pore size P1 desired to be obtained. A pore volume P2 in the second region was calculated by applying the above-described calculation also to the second region.

### <Measurement of Porosity>

First, the thickness ratio of the first region 61, which is a fixed ratio calculated in <Measurement Relating to Thickness Ratio of First Region and Second Region> described above, was applied to each cross-section imaged by the SEM. That is, the thickness 61t of the first region 61 and the thickness 62t of the second region 62 calculated in <Measurement Relating to Thickness Ratio of First Region and Second Region> were fixed, and the porosity in each of the fixed regions was calculated.

The SEM image described in (Observation of Cross-Section of Electrode Structure) of <Measurement Relating to Thickness Ratio of First Region and Second Region> was used. With respect to the SEM image, the solid particles and the binder were displayed to be white and voids were displayed to be black by a binarization treatment in which luminosity that is a median value between luminosity of the resin and luminosity of the interface between the composite layer and the active material-containing layer was set as a threshold value. A result obtained by calculating a ratio of the number of black pixels corresponding to voids to the number of all pixels in the SEM image was calculated as the porosity.

### Example 2

A battery was prepared in a similar manner as in Example 1 except that, with regard to Slurry 2 for forming a composite layer, a bimodal Al₂O₃ powder containing particles having mode diameters of 0.7 μm and 5 μm at a mass ratio of 2:1 was used as inorganic solid particles.

### Example 3

A battery was prepared in a similar manner as in Example 1 except that, with regard to Slurry 2 for forming a composite layer, a bimodal Al₂O₃ powder containing particles having mode diameters of 0.7 μm and 5 μm at a mass ratio of 5:1 was used as inorganic solid particles.

### Example 4

As Slurry 2 for forming a composite layer, the Al₂O₃ powder described in Example 1 as inorganic solid particles and PVdF as a polymer material were prepared, and the inorganic solid particles and the polymer material were mixed at a mass ratio of 92:8, and the resultant mixture was suspended in NMP as a solvent and was mixed for 30 minutes by using a mixer. A battery was prepared in a similar manner as in Example 1 except for the above description.

### Example 5

As Slurry 2 for forming a composite layer, the Al₂O₃ powder described in Example 1 as inorganic solid particles and PVdF as a polymer material were prepared, and the inorganic solid particles and the polymer material were mixed at a mass ratio of 94:6, and the resultant mixture was suspended in NMP as a solvent, and was mixed for 30 minutes by using a mixer. A battery was prepared in a similar manner as in Example 1 except for the above description.

### Example 6

A battery was prepared in a similar manner as in Example 1 except that the composite layer was applied to the surface layer of the negative electrode, and then the laminate was pressed at 2 kN.

### Example 7

A battery was prepared in a similar manner as in Example 1 except that molybdenum sulfide powder (MOS) was used as the negative electrode active material.

### Example 8

A battery was prepared in a similar manner as in Example 1 except that LATP was used instead of the Al₂O₃ powder for Slurry 1 and Slurry 2 for forming inorganic particles of the composite layer.

### Example 9

A battery was prepared in a similar manner as in Example 1 except that, with regard to Slurry 2 for forming a composite layer, a bimodal Al₂O₃ powder containing particles having mode diameters of 0.8 μm and 3 μm at a mass ratio of 5:1 was used as inorganic solid particles.

### Example 10

A battery was prepared in a similar manner as in Example 1 except that, with regard to Slurry 2 for forming a composite layer, a bimodal Al₂O₃ powder containing particles having mode diameters of 0.6 μm and 5 μm at a mass ratio of 1:1 was used as inorganic solid particles.

### Example 11

As Slurry 2 for forming a composite layer, the Al₂O₃ powder described in Example 1 as inorganic solid particles and PVdF as a polymer material were prepared, and the inorganic solid particles and the polymer material were mixed at a mass ratio of 87:13, and the resultant mixture was suspended in NMP as a solvent, and was mixed for 30 minutes by using a mixer. A battery was prepared in a similar manner as in Example 1 except for the above description.

### Example 12

A battery was prepared in a similar manner as in Example 1 except that the composite layer was applied to the surface layer of the negative electrode, and then the laminate was pressed at 8 kN.

### Comparative Example 1

A battery was prepared in a similar manner as in Example 1 Except that Slurry 1 for forming a composite layer and Slurry 2 for forming a composite layer were applied in an application thicknesses of 15 μm and 5 μm, respectively.

### Comparative Example 2

A battery was prepared in a similar manner as in Example 1 Except that Slurry 1 for forming a composite layer and Slurry 2 for forming a composite layer were applied in an application thicknesses of 4 μm and 18 μm, respectively.

### Comparative Example 3

A battery was prepared in a similar manner as in Example 1 except that the composite layer was applied to the surface layer of the negative electrode, and then the laminate was pressed at 0.3 kN.

### Comparative Example 4

A battery was produced in a similar manner as in Comparative Example 2 except that MOS was used as the negative electrode active material.

### Comparative Example 5

A battery was prepared in a similar manner as in Comparative Example 2 except that LATP was used instead of the Al₂O₃ powder for Slurry 1 and Slurry 2 for forming inorganic particles of the composite layer.

TABLE 1

| | Ratio | | | | | Charge | 2 C |
|---|---|---|---|---|---|---|---|
| | of | | | | | and | capacity |
| | first | | | | | discharge | retention |
| | region | | | | Porosity | efficiency | rate |
| | [%] | R1/R2 | N1/N2 | P1/P2 | [%] | [%] | [%] |
| Example 1 | 15 | 0.175 | 1.40 | 1.30 | 0.94 | 94 | 70 |
| Example 2 | 8 | 0.210 | 1.00 | 1.21 | 0.92 | 93 | 69 |
| Example 3 | 36 | 0.160 | 3.20 | 1.04 | 0.91 | 93 | 62 |
| Example 4 | 12 | 0.165 | 1.40 | 1.00 | 0.91 | 93 | 72 |
| Example 5 | 17 | 0.180 | 1.40 | 2.10 | 0.94 | 93 | 65 |
| Example 6 | 11 | 0.200 | 1.30 | 1.24 | 2.2 | 91 | 70 |
| Example 7 | 15 | 0.175 | 1.40 | 1.39 | 0.91 | 94 | 69 |
| Example 8 | 14 | 0.175 | 1.40 | 1.37 | 0.69 | 97 | 72 |
| Example 9 | 11 | 0.285 | 1.40 | 1.08 | 0.65 | 96 | 74 |
| Example 10 | 19 | 0.160 | 2.00 | 1.05 | 0.97 | 96 | 75 |
| Example 11 | 17 | 0.180 | 1.40 | 1.15 | 0.92 | 97 | 75 |
| Example 12 | 18 | 0.180 | 1.40 | 1.09 | 0.75 | 96 | 73 |

TABLE 2

| | Ratio | | | | | Charge | 2 C |
|---|---|---|---|---|---|---|---|
| | of | | | | | and | capacity |
| | first | | | | | discharge | retention |
| | region | | | | Porosity | efficiency | rate |
| | [%] | R1/R2 | N1/N2 | P1/P2 | [%] | [%] | [%] |
| Comparative | 50 | 0.16 | 1.40 | 0.85 | 0.94 | 89 | 41 |
| Example 1 | | | | | | | |
| Comparative | 4 | 0.31 | 3.10 | 0.92 | 0.98 | 88 | 28 |
| Example 2 | | | | | | | |
| Comparative | 18 | 7.15 | 1.10 | 0.68 | 0.94 | 74 | 43 |
| Example 3 | | | | | | | |
| Comparative | 50 | 7.15 | 1.10 | 0.68 | 0.91 | 74 | 37 |
| Example 4 | | | | | | | |
| Comparative | 50 | 7.15 | 1.10 | 0.68 | 0.99 | 75 | 44 |
| Example 5 | | | | | | | |

Table 1 shows the configuration of the electrode structure according to this embodiment and the evaluation results of the secondary battery experimentally prepared by using each electrode structure.

In Examples 1 to 12, the charge and discharge efficiency and the 2C capacity retention rate were higher as compared with Comparative Example 1. In Examples 1 to 12, unlike Comparative Example 1, the thickness ratio of the first region of the composite layer is low, that is, the first region is 40% or less of the thickness of the composite layer from the interface between the electrode and the composite layer. Since the first region in Examples 1 to 12 is within the above-described range, the thickness ratio of the second region is high, and thus a side reaction can be suppressed. This is because the second region contains more inorganic particles having an average particle size of 3 μm or more as compared with the first region, and the ratio of the second region in which a path through which water moves in the electrolyte is long is sufficiently large. If the path through which the water in the electrolyte moves in the second region is long, the path through which the solvent molecules pass through pores in the composite layer becomes long when the solvent molecules such as water in the electrolyte move toward the electrode. At this time, since a movement speed of solvent molecules such as water having a size close to a pore size from the composite layer to the active material-containing layer is suppressed in comparison to lithium having a small ionic radius, a side reaction including electrolysis of water in the electrode can be suppressed.

In Examples 1 to 12, the charge and discharge efficiency and the 2C capacity retention rate are higher as compared with Comparative Example 2, and the first region in Comparative Example 2 is 4%, which is less than 5% of the thickness of the composite layer from the interface between the electrode and the composite layer. In Examples 1 to 12, when the thickness ratio of the first region is 5% or more, the movement of solvent molecules such as water in the electrolyte at the interface between the composite layer and the active material-containing layer can be sufficiently accelerated. As a result, it is presumed that the resistance acting on the interface described above can be reduced, and the 2C capacity retention rate was increased. From the above description, in addition to the comparison between Example 1 to Example 12 and Comparative Example 1 described above, the first region is 5% or more and 40% or less of the thickness of the composite layer from the interface between the electrode and the composite layer. Therefore, it can be seen that the charge and discharge efficiency and the 2C capacity retention rate can be increased.

Examples 1 to 12 have higher 2C capacity retention rate as compared with Comparative Example 3. In Comparative Example 3, since the ratio of R1/R2 is larger than 1, it can be seen that R1 is larger than R2. In contrast, in Examples 1 to 12, R1 is smaller than R2. In Examples 1 to 12, since R2 is larger than R1, the average particle size of the inorganic particles in the second region is increased, the path through which water in the electrolyte moves in the second region is lengthened, and the side reaction can be suppressed, and thus it is presumed that the 2C capacity retention rate is increased.

When comparing Example 1 and Example 9 with each other, Example 9 has higher charge and discharge efficiency and higher 2C capacity retention rate as compared with Example 1. This is because R1/R2 in Example 9 is in a more preferable range of 0.25 or more and 0.5 or less.

When comparing Example 1 with Example 2 and Example 3, it can be seen that Example 1 has higher charge and discharge efficiency and higher 2C capacity retention rate. In Example 1, N1/N2 in the composite layer is larger as compared with Example 2, and is 1.1 or more and 5.0 or less. That is, it is suggested that in Example 1, the number N2 of particles of 0.2 μm or more and 3 μm or less in the second region is smaller as compared with the first region, and the number of alumina particles having an average particle size of 3 μm or more is large. Therefore, in Example 1, the path through which water in the electrolyte moves in the second region becomes long. It is considered that side reaction including electrolysis of water was suppressed by lengthening the path through which water in the electrolyte moves in the second region of the composite layer in Example 1, and as a result, the charge and discharge efficiency was high. From the above description, it is presumed that the range of N1/N2 is preferably 1.1 or more and 5.0 or less. In addition, in comparison between Example 1 and Example 3, the charge and discharge efficiency and 2C capacity retention rate are higher in Example 1 as compared with Example 3, it is presumed that N1/N2 is more preferably in a range of 1.1 or more and 4.0 or less. Further, in comparison between Example 1 and Example 10, since the charge and discharge efficiency and the 2C capacity retention rate are higher in Example 10 as compared with Example 1, it is presumed that N1/N2 is more preferably in a range of 1.5 or more and 3.0 or less as a more preferable range.

It can be seen that the charge and discharge efficiency and the 2C capacity retention rate in Example 1 are higher as compared with Examples 4 and 5. This is because in Example 1, unlike Example 4 and 5, P1/P2 in the composite layer is 1.01 or more and 2.0 or less. This represents that the size of the pores is smaller in the second region of Example 1, and it is considered that this makes it possible to suppress the movement of solvent molecules such as water from the composite layer toward the electrode, and a side reaction including electrolysis of water is suppressed, resulting in high charge and discharge efficiency. From the above description, it is presumed that the range of P1/P2 is preferably 1.01 or more and 2.0 or less. In addition, in comparison between Example 1 and Example 11, since the charge and discharge efficiency and the 2C capacity retention rate are higher in Example 11 as compared with Example 1, it is presumed that P1/P2 is more preferably in a range of 1.1 or more and 1.2 or less as a more preferable range.

Example 1 has higher charge and discharge efficiency as compared with Example 6. In Example 1, the porosity of the composite layer is lower than as compared with Example 6. In Example 1, it is presumed that due to the low porosity of the composite layer, a concentration distribution of protons is generated between the vicinity of the surface of the composite layer and the vicinity of the interface of the electrode and the composite layer, and a difference in pH is generated therebetween. It is considered that in Example 1, due to the above-described pH difference, the proton concentration in the active material layer was lowered, a side reaction including electrolysis of water was suppressed, and the charge and discharge efficiency was increased as compared with Example 6. From the above description, it is presumed that the porosity of the composite layer is preferably in a range of 0.60% or more and 1.0% or less as a more preferable range.

When comparing Comparative Examples 4 and 5 with Examples 6 and 7, it was confirmed that even when different materials were used for the active material and the inorganic particles of the composite layer as compared with Example 1, the thickness ratio of the first region was 5% or more and 40% or less, and R1/R2 was 0.01 or more and 0.8 or less, and thus the effect of increasing the 2C capacity retention rate was obtained.

As described above, regardless of the active material and the inorganic particles constituting the battery, the electrode structure according to this embodiment includes the electrode and the composite layer containing the inorganic particles, the composite layer has the first region and the second region, the first region exists between the electrode and the second region, and in the cumulative frequency distribution of the inorganic particles which are contained in the composite layer and have an average particle size of 3 μm or more with respect to the thickness direction of the composite layer, when the total number of inorganic particles having an average particle size of 3 μm or more is normalized to 100, and the first region is set to a region where the cumulative frequency of the inorganic particles having an average particle size of 3 μm or more is in a range of 0 or more and less than 25, the first region has a thickness of 5% or more and 40% or less of the thickness of the composite layer from the interface between the electrode and the composite layer, and the average particle size R1 of the inorganic particles in the first region and the average particle size R2 of the inorganic particles in the second region satisfy a relationship of R1<R2 in a cross-sectional SEM image of the composite layer in the thickness direction, and thus it is possible to reduce the resistance while suppressing the electrolysis of water accompanying the side reaction.

Although some embodiments of the invention have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the appended claims and the equivalent scope thereof.

Hereinafter, a supplementary note according to the embodiment will be described.

[1]

An electrode structure for a secondary battery, including:
an electrode; and
a composite layer containing inorganic particles,
wherein the composite layer includes a first region and a second region,
the first region exists between the electrode and the second region,
in a cumulative frequency distribution of the inorganic particles having an average particle size of 3 μm or more in the composite layer with respect to a thickness direction of the composite layer, when the total number of the inorganic particles having the average particle size of 3 μm or more is normalized to 100, and the first region is set to a range in which a cumulative frequency of the inorganic particles having the average particle size of 3 μm or more is 0 or more and less than 25 and the second region is set to a range 25 or more and 100 or less,
the first region is 5% or more and 40% or less of the thickness of the composite layer from an interface between the electrode and the composite layer, and
in a cross-sectional SEM image of the composite layer, an average particle size R1 of the inorganic particles in the first region and an average particle size R2 of the inorganic particles in the second region satisfy a relationship of R1<R2.
   [2]

The electrode structure according to [1], wherein the number N1 of the inorganic particles having an average particle size of 0.2 μm or more and 3 μm or less in the first region and the number N2 of the inorganic particles having an average particle size of 0.2 μm or more and 3 μm or less in the second region satisfy a relationship of N1>N2.

[3]

The electrode structure according to [2], wherein a ratio N1/N2 of the number N1 of the inorganic particles having an average particle size of 0.2 μm or more and 3 μm or less to the number N2 of the inorganic particles having an average particle size of 0.2 μm or more and 3 μm or less is 1.1 or more and 5.0 or less.

[4]

The electrode structure according to any one of [1] to [3], wherein an average pore size P1 in the first region and an average pore size P2 in the second region satisfy a relationship of P1>P2.

[5]

The electrode structure according to [4], wherein a ratio P1/P2 of the average pore size P1 to the average pore size P2 is 1.01 or more and 2.0 or less.

[6]

The electrode structure according to any one of [1] to [5], wherein a ratio R1/R2 of the average particle size R1 to the average particle size R2 is 0.01 or more to 0.8 or less.

[7]

The electrode structure according to any one of [1] to [6], wherein the composite layer has a porosity of 0.10% or more and 4.0% or less.

[8]

The electrode structure according to any one of [1] to [7], wherein the electrolyte is an aqueous electrolyte.

[9]

A secondary battery, including:
the electrode structure according to any one of [1] to [8]; and
a counter electrode.
   [10]

The secondary battery according to [9], wherein the counter electrode is a positive electrode.

[11]

A battery pack, including: the secondary battery according to [9] or [10].

[12]

The battery pack according to [11], further including: an external power distribution terminal; and a protection circuit.

[13]

The battery pack according to or [12], further including: a plurality of the secondary batteries, wherein the plurality of secondary batteries are electrically connected in series, in parallel, or in combination of series connection and parallel connection.

[14]

A vehicle, including: the battery pack according to any one of to [13].

[15]

The vehicle according to [14], further including: a mechanism that converts kinetic energy of the vehicle into regenerative energy.

A stationary power supply, including: the battery pack according to any one of [11] to [13].

What is claimed is:

1. An electrode structure for a secondary battery, comprising:
an electrode; and
a composite layer containing inorganic particles,
wherein the composite layer includes a first region and a second region,
the first region exists between the electrode and the second region,
in a cumulative frequency distribution of the inorganic particles which are contained in the composite layer and have an average particle size of 3 μm or more with respect to a thickness direction of the composite layer, when the total number of the inorganic particles having the average particle size of 3 μm or more is normalized to 100, and the first region is set to a range where a cumulative frequency of the inorganic particles having the average particle size of 3 μm or more is 0 or more and less than 25 and the second region is set to a range 25 or more and 100 or less,
the first region is 5% or more and 40% or less of the thickness of the composite layer from an interface between the electrode and the composite layer, and
in a cross section of the composite layer in the thickness direction, an average particle size R1 of the inorganic particles in the first region and an average particle size R2 of the inorganic particles in the second region satisfy a relationship of R1<R2.

2. The electrode structure according to claim 1, wherein the number N1 of the inorganic particles having an average particle size of 0.2 μm or more and 3 μm or less in the first region and the number N2 of the inorganic particles having an average particle size of 0.2 μm or more and 3 μm or less in the second region satisfy a relationship of N1>N2.

3. The electrode structure according to claim 2, wherein a ratio N1/N2 of the number N1 of the inorganic particles having an average particle size of 0.2 μm or more and 3 μm or less to the number N2 of the inorganic particles having an average particle size of 0.2 μm or more and 3 μm or less is 1.1 or more and 5.0 or less.

4. The electrode structure according to claim 1, wherein an average pore size P1 in the first region and an average pore size P2 in the second region satisfy a relationship of P1>P2.

5. The electrode structure according to claim 4, wherein a ratio P1/P2 of the average pore size P1 to the average pore size P2 is 1.01 or more and 2.0 or less.

6. The electrode structure according to claim 1, wherein a ratio R1/R2 of the average particle size R1 to the average particle size R2 is 0.01 or more and 0.8 or less.

7. The electrode structure according to claim 1, wherein a porosity of the composite layer is 0.1% or more and 4.0% or less.

8. The electrode structure according to claim 1, wherein the electrolyte is an aqueous electrolyte.

9. A secondary battery, comprising:
the electrode structure according to claim 1; and
a counter electrode.

10. The secondary battery according to claim 9, wherein the counter electrode is a positive electrode.

11. A battery pack, comprising: the secondary battery according to claim 9.

12. The battery pack according to claim 11, further comprising:
an external power distribution terminal; and
a protection circuit.

13. The battery pack according to claim 11, further comprising: a plurality of the secondary batteries, wherein the plurality of secondary batteries are electrically connected in series, in parallel, or in combination of series connection and parallel connection.

14. A vehicle, comprising: the battery pack according to claim 11.

15. The vehicle according to claim 14, further comprising:
a mechanism that converts kinetic energy of the vehicle into regenerative energy.

16. A stationary power supply, comprising: the battery pack according to claim 11.
